(19) United States
(12) Patent Application Publication
(10) Pub. No.: US 2025/0294492 A1
(43) Pub. Date: Sep. 18, 2025

(54) USER EQUIPMENT, NETWORK NODE, AND METHODS FOR HANDLING COMMUNICATIONS

(71) Applicant: Telefonaktiebolaget LM Ericsson (publ), Stockholm (SE)

(72) Inventors: Lian ARAUJO, Solna (SE); Alessio TERZANI, Stockholm (SE); Tomas FRANKKILA, Luleå (SE); Nianshan SHI, Järfälla (SE); Mai-Anh PHAN, Herzogenrath (DE)

(21) Appl. No.: 18/699,410

(22) PCT Filed: Oct. 18, 2022
(86) PCT No.: PCT/SE2022/050942

§ 371 Date: Apr. 8, 2024

Related U.S. Application Data
(60) Provisional application No. 63/262,760, filed on Oct. 20, 2021.

(51) Int. Cl. H04W 60/04; H04W 8/22; H04W 76/20

(52) U.S. Cl. CPC H04W 60/04; H04W 8/22; H04W 76/20

(57) ABSTRACT

A method performed by a UE having at least two SIM for simultaneous communication with two or more networks. The UE registers with a first wireless communications network associated with a first SIM, by providing, to a first network node, a first information comprising one or more first capabilities of the UE. The UE further registers with a second wireless communications network associated with a second SIM, by providing, to a second network node, a second information comprising one or more second capabilities of the UE. Upon being connected to the first wireless communications network and using the one or more first capabilities from the first information for a service, the UE triggers a first request to the first network node to disable a set of capabilities from the one or more first capabilities in the first information provided to the first network node.

### TECHNICAL FIELD

Embodiments herein relate to a user equipment (UE), a network node, and methods performed therein regarding wireless communication. Furthermore, a computer program product and a computer-readable storage medium are also provided herein. In particular, embodiments herein relate to handling communication, such as handling operation of a multi-Subscriber Identity Module (SIM) user equipment.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by radio network node such as an access node, e.g., a Wi-Fi access point or a radio base station (RBS), which in some networks may also be called, for example, a NodeB, a gNodeB, or an eNodeB. The service area or cell area is a geographical area where radio coverage is provided by the radio network node. The radio network node operates on radio frequencies to communicate over an air interface with the UEs within range of the radio network node. The radio network node communicates over a downlink (DL) to the UE, and the UE communicates over an uplink (UL) to the radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 6G networks and development of 5G such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies, such as new radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Next generation systems are expected to support a wide range of use cases with varying requirements ranging from fully mobile devices to stationary internet of things (IoT) or fixed wireless broadband devices. The traffic pattern associated with many use cases may be expected to consist of short or long bursts of data traffic with varying length of waiting period in between, here called inactive state. In NR, both license assisted access and standalone unlicensed operation are to be supported. Hence, the procedure of Physical Random Access Channel (PRACH) transmission and/or Scheduling Request (SR) transmission in unlicensed spectrum may be investigated in 3GPP.

Multiple Subscriber Identity Module (SIM), or “Multi-SIM” or “Multi-USIM,” devices are devices which enable use of multiple subscriptions in one device using more than one Universal Mobile Telecommunications System (UMTS) Subscriber Identity Module (SIM or USIM). Multi-SIM UE's can support concurrent registration to more than one network simultaneously and, e.g., if a UE has two different radios implemented, such as both dual receive (Rx) and dual transmit (Tx) capability, it would be possible for the UE to behave as two separate UEs and communicate with two networks at the same time. There are also dual or multi-SIM capable UEs that only have one single radio front-end and baseband processing.

A single UE, which is capable of having two or more subscription credentials, may thus act as two UEs within one device/hardware entity. The ability of a UE to support multiple USIMs (MUSIM) has become a mainstream feature. For example, a user may have a work SIM, a private SIM, and other SIMs for other purposes, which may be used in one or more UEs. As another example, mobile devices such as a smartphone, a smartwatch and other wearables, need to have multi-SIM capability to be able to connect to the same mobile number. Multi-SIM capability for voice calls means that a user may be reached at the same mobile number via these devices without connecting via the smartphone.

MUSIM devices, e.g., UEs with more than one receiver (Rx) and/or transmitter (Tx), may simultaneously connect to more than one network such as a Public Land Mobile Network (PLMN). Factors such as, e.g., different possible network configurations and a changing demand for diverse types of operations, e.g., multi-carrier, may affect the complexity of such frameworks. For example, for UEs with dual Rx and dual Tx radios, certain services on one network may require both radios to satisfy quality of service (QOS) requirements, leaving no resources for another network.

It remains a challenge to manage and support UEs that can have two or more simultaneous subscriptions with more than one network. For example, even though mobile terminals with Multi-SIM functionality exist, there is no specific standardized support for Multi-USIM devices such that various UE implementations and behaviors exist. For example, it may not be possible for a UE to receive and/or send data using one subscription, while having an ongoing service with another subscription. For UEs with dual Tx and dual Rx using static UE assistance information, available resources may be underutilized. Furthermore, service quality at a network may need to be controlled when UE capabilities are changed such as downgraded or restored.

### SUMMARY

An object herein is to provide improved handling of operation of a multi-SIM UE. More specifically, embodiments of the present disclosure provide a way for a UE to trigger an indication to a wireless communications network regarding disabling and may further reenable certain capabilities for communications with the wireless communications network. Disabling some of the capabilities allows the UE communicating with at least one another wireless communications network while retaining communications with the wireless communications network. Thus, the UE is enabled to be simultaneously connected, e.g., in RRC_CONNECTED mode, with multiple wireless communications networks to adapt the configuration of the available radio resources to the UE's current needs and/or situation. When UE capabilities change, e.g., they are downgraded or restored, the UE triggers a request to a network which has control over the service quality level that has been negotiated for ongoing services. Furthermore, when the UE services are restored after a temporary downgrade, the network will know whether there are sufficient radio and/or network resources to restore the services for the UE.

According to an aspect of the present disclosure, the object is achieved by providing a method performed by a UE having at least two SIMs for simultaneous communication with two or more wireless communications networks. The UE registers, with a first wireless communications network associated with a first SIM, by providing, to a first network node associated with the first wireless communications network, a first information comprising one or more first capabilities of the UE. The UE further registers with a second wireless communications network associated with a second SIM, by providing, to a second network node associated with the second wireless communications network, a second information comprising one or more second capabilities of the UE. Upon being connected to the first wireless communications network and using the one or more first capabilities from the first information for a service, the UE triggers a first request to the first network node to disable a set of capabilities from the one or more first capabilities in the first information provided to the first network node.

According to an aspect of the present disclosure, the object is achieved by providing a method performed by a first network node associated with a first wireless communications network. The first network node obtains a registration, with the first wireless communications network associated with a first SIM, by receiving, from a UE, first information comprising one or more first capabilities of the UE, wherein the UE is simultaneously registered with the first wireless communications network and at least one second wireless communications network associated with a second SIM. The first network node further receives a first request to disable a set of capabilities from the one or more first capabilities in the first information comprising one or more capabilities of the UE, when the UE is connected to the first wireless communications network and uses the one or more first capabilities from the first information for a service.

According to a further aspect of the present disclosure, the object is achieved by providing the UE having multiple SIMs, for simultaneous communication with two or more wireless communications networks, wherein the UE is configured to register, with a first wireless communications network associated with a first SIM, by providing, to a first network node associated with the first wireless communications network, a first information comprising one or more first capabilities of the UE. The UE is further configured to register, with a second wireless communications network associated with a second SIM, by providing, to a second network node associated with the second wireless communications network, a second information comprising one or more second capabilities of the UE. The UE is configured to, upon being connected to the first wireless communications network and using the one or more first capabilities from the first information for a service, trigger a first request to the first network node to disable a set of capabilities from the one or more first capabilities in the first information provided to the first network node.

According to a further aspect of the present disclosure, the object is achieved by providing a first network node associated with a first wireless communications network. The first network node is configured to obtain a registration with the first wireless communications network associated with a first SIM, by receiving, from a UE, first information comprising one or more first capabilities of the UE, wherein the UE is simultaneously registered with the first wireless communications network and at least one second wireless communications network associated with a second SIM. The first network node is further configured to receive a first request to disable a set of capabilities from the one or more first capabilities in the first information comprising one or more first capabilities of the UE, when the UE is connected to the first wireless communications network and uses the one or more first capabilities from the first information for a service.

It is furthermore provided herein a computer program product comprising instructions, which, when executed on at least one processor, cause the at least one processor to carry out the methods herein, as performed by the UE and the first network node, respectively. It is additionally provided herein a computer-readable storage medium, having stored thereon a computer program product comprising instructions which, when executed on at least one processor, cause the at least one processor to carry out the methods herein, as performed by the UE and the first network node, respectively.

The object is achieved by providing a UE and a network node configured to perform the methods herein, respectively.

Embodiments herein allow supporting a UE dual connectivity in more than one wireless communications network. The UE can stay in RRC_CONNECTED mode simultaneously on two or more networks, for Multi-SIM purposes. Furthermore, UE capability coordination with a wireless communications network is enabled, by switching partial capability, e.g., frequencies, and/or Tx or Rx chains, from or to the wireless communications network. Thus, embodiments herein enable communication of multi-SIM UEs in an efficient manner in a wireless communications network, and thereby improve the overall performance of the wireless communications network and/or improve user experience.

### BRIEF DESCRIPTION OF THE DRAWINGS

Embodiments will now be described in more detail in relation to the enclosed drawings, in which:

FIG. 1A is a schematic overview depicting a wireless communications network in accordance with some embodiments of the present disclosure;

FIG. 1B is a combined signalling scheme and flowchart, showing communications between a UE and first and second network nodes, in accordance with some embodiments;

FIG. 2 is a schematic flowchart illustrating a method performed by a UE, in accordance with some embodiments;

FIG. 3 is a schematic flowchart illustrating a method performed by a network node, in accordance with some embodiments;

FIG. 4 is a combined signalling scheme and flowchart, showing communications between a UE and first and second network nodes, in accordance with some embodiments;

FIGS. 5A and 5B are block diagrams depicting a UE in accordance with some embodiments;

FIGS. 6A and 6B are block diagrams depicting a network node in accordance with some embodiments;

FIG. 7 illustrates a telecommunication network connected via an intermediate network to a host computer, in accordance with some embodiments;

FIG. 8 illustrates a host computer communicating via a base station with a user equipment over a partially wireless connection, in accordance with some embodiments;

FIG. 9 is a flowchart illustrating methods implemented in a communication system including a host computer, a base station, and a user equipment, in accordance with some embodiments;

FIG. 10 is another flowchart illustrating methods implemented in a communication system including a host computer, a base station, and a user equipment, in accordance with some embodiments;

FIG. 11 is another flowchart illustrating methods implemented in a communication system including a host computer, a base station, and a user equipment, in accordance with some embodiments; and

FIG. 12 is another flowchart illustrating methods implemented in a communication system including a host computer, a base station, and a user equipment, in accordance with some embodiments.

### DETAILED DESCRIPTION

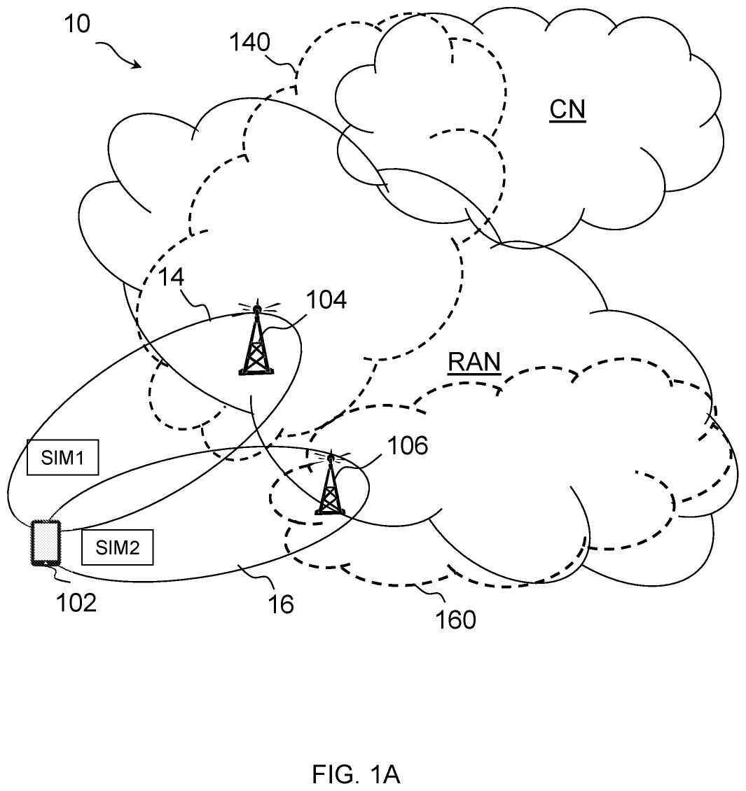

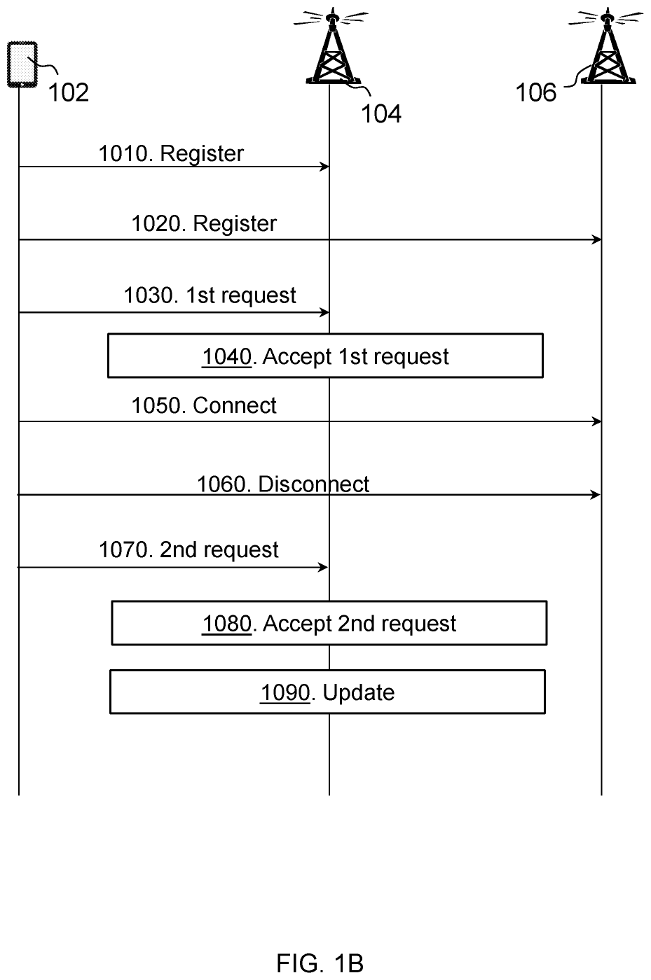

Embodiments herein relate to wireless communications networks in general. FIG. 1A is a schematic overview depicting a wireless communications network 10. The wireless communications network 10 comprises one or more RANs and one or more CNs. The wireless communications network 10 may use one or a number of different technologies. Embodiments herein relate to recent technology trends that are of particular interest in a New Radio (NR) context, however, embodiments are also applicable in further developments of existing wireless communications systems such as e.g. LTE or Wideband Code Division Multiple Access (WCDMA).

In the wireless communications network 10, a user equipment (UE) 102, such as a mobile station, a wireless device, a non-access point (non-AP) STA, a STA, and/or a wireless terminal, is communicating via e.g. one or more Access Networks (AN), e.g. RAN, to one or more core networks (CN). It should be understood by the skilled in the art that “UE” is a non-limiting term which means any terminal, wireless communications terminal or device, user equipment, NB-IoT device, Machine Type Communication (MTC) device, Device to Device (D2D) terminal, or node, e.g. smart phone, laptop, mobile phone, sensor, relay, mobile tablets or even a small base station capable of communicating using radio communication with a radio network node within an area served by the radio network node.

The wireless communications network 10 comprises one or more first network nodes.

The wireless communications network 10 comprises a first network node 104, e.g., an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), MME, AMF, a stand-alone access point, or any other network unit or node capable of communicating with a wireless device within a service area 14 served by the radio network node depending e.g., on a radio access technology and terminology used. The service area 14 may also be referred to as a beam or a beam group of a first radio access technology (RAT), such as 5G, LTE, Wi-Fi, or similar. The first network node 104 may be associated with and provide radio communication in a first wireless communications network 140, such as, e.g., a first Public Land Mobile Network (PLMN) or a first Non-Public Network (NPN). In some embodiments, the first wireless communications network 140 may be implemented as a combination of a PLMN and an NPN.

The wireless communications network 10 also comprises a second network node 106, e.g., an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), MME, AMF, a stand-alone access point, or any other network unit or node capable of communicating with a wireless device within a service area 16 served by the radio network node depending e.g., on a radio access technology and terminology used. The service area 16 may also be referred to as a beam or a beam group of a first radio access technology (RAT), such as 5G, LTE, Wi-Fi, or similar. The second network node 106 may be associated with and provide radio communication in a second wireless communications network 160, such as, e.g., a second PLMN or a second NPN. In some embodiments, the second wireless communications network 160 may be implemented as a combination of a PLMN and an NPN.

Embodiments of the present disclosure relate to multi-SIM, or MUSIM, devices that can enable users to be registered to multiple networks, such as PLMNs, NPNs, or a combination thereof. For instance, UEs equipped with dual radio capabilities may enable simultaneous connection to two wireless communications networks.

As shown in FIG. 1A, the UE 102 may thus be a multi-SIM UE and it may have a first SIM, shown as SIM1, and a second SIM, shown as SIM2, though it should be appreciated that the UE 102 may have more than two SIMs. In the illustrated embodiment, the first wireless communications network 140, such as the first PLMN or NPN, is associated with the first SIM of the UE 102, and the second wireless communications network 160, such as the second PLMN or NPN, is associated with the second SIM of the wireless communication device.

The UE 102 may be registered with both the first and second wireless communications networks 140, 160, which may be respective PLMNs, NPNs, a combination of PLMN(s) and NPN(s), or any other wireless communications networks that may be of the same or different types. As used herein, a PLMN is defined as a wireless communications network that provides a combination of wireless communication services offered by an operator. As used herein, an NPN is defined as a private network that is deployed for private use by an entity such as a government, company, or another entity. In some embodiments, when the UE 102 has multiple SIMs, the different SIMs are associated with different PLMNs or NPNs. In some embodiments, the UE 102 may have more than one SIM which is associated with the same network such as a PLMN and/or NPN, e.g., the UE 102 may have two SIMs from the same operator.

Some aspects of the present disclosure may be implemented in connection with the radio resource control (RRC) protocol.

In some embodiments, aspects of the present disclosure may be implemented in a cloud environment.

The UE 102 may have more than one radio, such as, e.g., both dual receive (Rx) and dual transmit (Tx) capability. The radios may support RRC Connected mode in a network, e.g., one of the first and second wireless communications networks 140, 160, without interrupting service of the other network, e.g., the other one of the first and second wireless communications networks 140, 160.

The number of Rx/Tx radio chains may play a role on how multi-SIM UEs are managed. Furthermore, different possible network configurations and a changing demand for diverse types of operations may affect the complexity of handling communications of multi-SIM UEs which may communicate with multiple wireless communications networks.

In 3GPP, it is currently addressed in Rel-17 how to properly support UEs that can manage two or more simultaneous subscriptions. Several aspects may be addressed. For example, a UE may need to be provided support to easier switch between states related to utilization of subscription 1, USIM1, connecting to a PLMN1, and states related to utilization or communication using subscription 2, USIM2, connecting to PLMN2, as such states may be dependent, e.g., RRC_CONNECTED in PLMN1 and PLMN2. Such switching may be straightforward, or may not even be necessary if the UE has the capability of communicating simultaneously towards two wireless communications networks, using USIM1 and USIM2 simultaneously. For this to work, there may be a need for at least dual receiver and transmitter chains, operating so that frequencies that are used towards both wireless communications networks do not cause interference to each other and so that radio separation is good enough to not cause, e.g., intermodular (IM) effects in the device. Yet other aspects that can be addressed by a standard is to introduce a signaling that allows a UE that cannot simultaneously communicate with, e.g., two or more wireless communications networks, to at least signal to a wireless communications network that the UE is leaving, or becoming unreachable for that wireless communications network.

As described in RP-202895, “Support for Multi-SIM devices for LTE/NR,” 3GPP TSG RAN Meeting #90e. Electronic Meeting, Dec. 7-11, 2020. China Telecom, China Unicom, the release (Rel)-17 work on Multi-USIM includes the following objectives:
1. Specify, if necessary, enhancement(s) to address the collision due to reception of paging when the UE is in RRC_IDLE/RRC_INACTIVE mode in both the networks associated with respective SIMs [RAN2]
   a. RAT Concurrency: Network A can be NR or LTE. Network B can either be LTE or NR.
   b. Applicable UE architecture: Single-Rx/Single-Tx.
2. Specify mechanism for UE to notify Network A of its switch from Network A (for MUSIM purpose) [RAN2]:
   a. RAT Concurrency: Network A is NR. Network B can either be LTE or NR.
   b. Applicable UE architecture: Single-Rx/Single-Tx, Dual-Rx/Single-Tx.
3. Unless SA2 find an alternative solution or decides otherwise, specify mechanism for an incoming page to indicate to the UE whether the service is voice over LTE (VOLTE) or voice over NR (VoNR) [RAN2].
   a. RAT Concurrency: Network A is either LTE or NR. Network B is either LTE or NR.
   b. Applicable UE architecture: Single-Rx/Dual-Rx/Single-Tx.

In the current framework for Multi-USIM study in Rel-17, it is assumed that the UE is not able to stay in RRC_CONNECTED in two wireless communications networks simultaneously, e.g., it is not possible for the UE to receive/send data using one subscription while having an ongoing service with another subscription. For UEs with dual Tx and dual Rx using static UE assistance information, the available resources may be underutilized.

According to embodiments herein it is provided an improved way for a UE, such as a multi-SIM enabled UE, to indicate or provide a preference to temporarily reduce UE capabilities for Multi SIM purposes. UEs and methods in accordance with embodiments of the present disclosure enable the UE to be simultaneously in RRC_CONNECTED with multiple wireless communications networks to adapt the configuration of the available radio resources to the UE's current needs and/or situation, e.g., maximizing the throughput for data transmission/reception using one subscription while having/maintaining a phone call with another subscription.

When the UE capabilities are changed, e.g., downgraded or restored, the wireless communications network has control over the service quality level that has been negotiated for the ongoing services. For example, the wireless communications network may control a service level when the UE capabilities are restored after a temporary downgrade, since other UEs may have started other services meanwhile, and it is only the wireless communications network that knows if there are sufficient radio and/or network resources to restore the services for the UE 102, which was downgraded. The wireless communications network may in certain cases, e.g., if the QoS parameters were downgraded or the session was renegotiated to a lower service quality, rerun the admission control before the UE 102 can start using the restored capabilities.

As an example, when the UE 102 is registered with network A only, the UE 102 may provide its capability information to network A, which corresponds to a situation when the UE 102 is only using one of the SIMs. This means that it corresponds to a single-SIM UE and all capabilities that are available in the UE, e.g., frequencies, carrier combinations, features, processing, etc., are available for use with network A.

According to embodiments herein the UE 102 can communicate with two different wireless communications networks simultaneously. Thus, for example, when the UE 102 is registered with PLMN1 and PLMN2, or other types of wireless communications networks, at the same time, the UE 102 may, as in the case when the UE 102 is registered with one network only, provide full capabilities to network A and network B.

FIG. 1B is a combined flowchart and signalling scheme depicting some embodiments herein.

Action 1010. The UE 102 registers to the first network node 104 associated with the first SIM. The UE 102 may register by providing, to the first network node 104, a first information comprising one or more first capabilities of the UE 102.

Action 1020. The UE 102 registers to the second network node 106 associated with the second SIM. The UE 102 may register by providing, to the second network node 106, a second information comprising one or more second capabilities of the UE 102.

Action 1030. The UE 102 sends a first request to the first network node 104 to disable a set of capabilities from the one or more first capabilities in the first information provided to the first network node 104.

Action 1040. The first network node 104 accepts the first request and disables the set of capabilities for communication with the UE 102.

Action 1050. The UE 102 may then connect to the second network node 106 using the set of capabilities.

Action 1060. The UE 102 may later disconnect from the second network node 106.

Action 1070. When the UE 102 disconnects from the second network node 106 and may continue to be connected to the first wireless communications network using the reduced capabilities, the UE 102 may transmit a second request, to the first network node 104, to reenable the set of capabilities for communication with the first wireless communications network.

Action 1080. The first network node 104 may then accept the second request.

Action 1090. The first network node 104 may update and reenable the set of capabilities for communication with the UE 102 to thereby allow the UE 102 to revert to using at least a portion of the reenabled set of capabilities from the first information comprising the one or more first capabilities of the UE 102 to connect to the first wireless communications network.

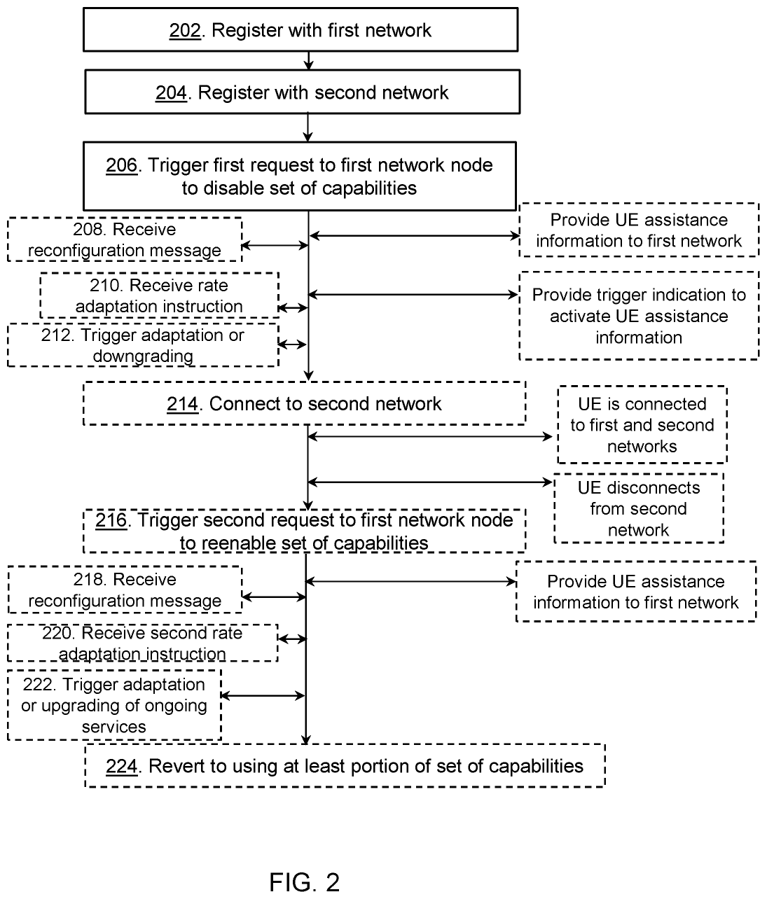

FIG. 2 illustrates an example of a method performed by a multi-SIM enabled UE, such as the UE 102, in accordance with embodiments of the present disclosure. The UE 102 has the first and second SIMs. In some embodiments, the UE has multiple SIMs, e.g., three, four, five, six, or more than six SIMs.

Optional actions are shown using a dashed line. The acts of FIG. 2 may be performed in any suitable order.

Action 202. The UE 102 registers with the first wireless communications network associated with the first SIM, e.g., first network 140 of FIG. 1A. The UE 102 may register with the first wireless communications network, by providing, to the first network node, e.g., first network node 104, associated with the first wireless communications network, the first information comprising the one or more first capabilities of the UE 102. The one or more first capabilities of the UE 102 in the first information comprise UE capabilities relevant to the first wireless communications network. In some embodiments, the first information comprises information on full capabilities of the UE 102.

The first information, which may comprise information on full capabilities of the UE 102, may comprise information on one or more out of: a) a number of carriers supported by the UE; b) one or more carrier combinations supported by the UE; c) one or more processing capabilities of the UE; d) one or more features supported by the UE; e) a number of radio frontends that the UE has; f) a bandwidth supported by the UE; g) a buffer or memory size supported by the UE; h) a number of PDN connections or PDU connections supported by the UE; i) one or more carrier aggregation related capabilities of the UE; and j) one or more dual connectivity related capabilities of the UE. In some embodiments, registering with the first wireless communications network comprises being configured by the first network node 104 based on the first information comprising the one or more first capabilities of the UE. The first network node 104 configures the UE 102 according to the one or more first capabilities of the UE 102 provided to the first network node 104.

Action 204. The UE 102 may register with the second wireless communications network associated with a second SIM, e.g., second wireless communications network 160 of FIG. 1A. The UE 102 register with the second wireless communications network, by providing, to the second network node, e.g., second network node 106, associated with the second wireless communications network, the second information comprising the one or more second capabilities of the UE 102. The one or more second capabilities of the UE 102 in the second information comprise UE capabilities relevant to the second wireless communications network. In some embodiments, the second information comprises information on full capabilities of the UE 102.

The second information, which may comprise information on full capabilities of the UE 102, may comprise information on one or more out of: a) a number of carriers supported by the UE; b) one or more carrier combinations supported by the UE; c) one or more processing capabilities of the UE; d) one or more features supported by the UE; e) a number of radio frontends that the UE has; f) a bandwidth supported by the UE; g) a buffer or memory size supported by the UE; h) a number of PDN connections or PDU connections supported by the UE; i) one or more carrier aggregation related capabilities of the UE; and j) one or more dual connectivity related capabilities of the UE.

The one or more first capabilities may be the same, partly the same, or different capabilities as to the one or more second capabilities.

In some embodiments, registering with the second network comprises being configured by the second network node 106 based on the second information comprising the one or more second capabilities of the UE 102. The second network node 106 configures the UE 102 according to the one or more second capabilities of the UE 102 provided to the second network node 106.

In some embodiments, thus, the UE 102 may be configured by a network node, such as one or both the first and second network nodes, or any other network nodes, to provide UE assistance information, and other related information, to the network node, due to the network node awareness that the UE 102 is a Multi-USIM UE.

The UE 102 may thus be simultaneously registered with the first and second wireless communications networks. In some embodiments, the first wireless communications network and the second wireless communications network are different networks. In some embodiments, the first wireless communications network and the second wireless communications network are the same network.

In some embodiments, the first wireless communications network is NR, and the second wireless communications network is LTE or NR. In some embodiments, the first wireless communications network is LTE or NR, and the second wireless communications network is NR.

Information e.g. about one or more out of the UE behavior, traffic pattern(s), and UE-assisted information (UAI), may be conveyed from the first wireless communications network to the second wireless communications network, or vice versa. For example, the information may be included in a transparent container and passed from one network to another via CN. The wireless communications network which receives the information, upon the reception of such information, may make more informed decisions regarding preconfiguring and predicting.

The first wireless communications network may be a first PLMN or a first NPN, and the second wireless communications network may be a second PLMN or a second NPN. In some embodiments, the first and second wireless communications networks may both be PLMNs or NPNs. In some embodiments, the first wireless communications network is a PLMN and the second wireless communications network is an NPN. In some embodiments, the first wireless communications network is an NPN and the second wireless communications network is an PLMN. In some embodiments, one or both the first and second wireless communications networks are a combination of a PLMN and an NPN.

As used herein, that the UE 102 is registered with a wireless communications network, such as with a PLMN or an NPN, means that the UE 102 receives and/or transmits signals with that wireless communications network when in a connected mode. The UE 102 may also be registered with the wireless communications network when in idle mode, in which case the UE 102 is at least ready to receive some signals (e.g., paging signals) from that wireless communications network.

After the UE 102 has been registered in the first and second wireless communications networks, and the respective relevant UE capabilities have been provided to the first and second wireless communications networks, the UE 102 may be disconnected from the first and second wireless communications networks.

At some point, the UE 102 may start a service in the first wireless communications network. Thus, the UE 102 becomes connected to the first wireless communications network and may be disconnected from the second wireless communications network. The UE 102 may be in an RRC_CONNECTED mode in the first wireless communications network, while the UE 102 is in an RRC_IDLE mode, or state, or an RRC_INACTIVE mode or state in the second wireless communications network.

Action 206. The UE 102 triggers the first request to the first wireless communications network to disable the set of capabilities. The first request may be triggered when the UE 102 needs to connect to the second wireless communications network. In some embodiments, upon being connected to the first wireless communications network and using the one or more first capabilities for a service, the UE 102 triggers the first request to the first network node 104 to disable the set of capabilities from the one or more first capabilities e.g. in the first information provided to the first network node 104 or the one or more first capabilities configured by the first network. Thus, the UE 102 indicates to the first network node 104 that some of the one or more first capabilities, which may be the capabilities that the UE 102 previously provided to the first network node 104, be temporary disabled. For example, certain carrier frequencies may need to be disabled, to allow the UE 102 to connect to the second wireless communications network as well.

The set of capabilities that the UE 102 requests the first wireless communications network to disable may be one or more capabilities from the first information provided to the first network node 104 by the UE 102. The first wireless communications network may disable capabilities based on the requested set of capabilities it receives, such that the UE 102 communicates with the first network node 104 using reduced capabilities.

The first information may comprise one or more carrier frequencies, wherein the set of capabilities from the one or more first capabilities in the first information comprises at least one carrier frequency from the one or more carrier frequencies.

The first request may comprise a UE assistance information, such that the UE 102 provides the UE assistance information to the first network node 104.

The UE assistance information may comprise one or more of: an indication in an In-Device-Coexistence (IDC) assistance information; an indication in the IDC assistance information in combination with a MUSIM indication; and a MUSIM assistance information. In some embodiments, the MUSIM assistance information is separated from the IDC assistance information and the IDC assistance information is not modified due to MUSIM.

The first request to the first network node 104 may be provided in response to a change in at least one condition of the UE 102 in at least one of the first and second wireless communications networks, wherein the change in the at least one condition comprises a channel condition and/or a change of data demands. When a change in one or more conditions on the wireless communications network to which the UE 102 is connected, such as the first wireless communications network or the second wireless communications network, occurs, depending on different aspects related to the wireless communications network, the UE 102 may decide to trigger a UE assistance information report or trigger to send an activation request, discussed below, for one or more elements provided in the UE assistance information.

The at least one condition may comprise a channel condition. For example, the channel conditions for one of the wireless communications networks, e.g., the first wireless communications network, may have become worse while the channel conditions were improved for another wireless communications network, e.g., the second wireless communications network; thus, the UE 102 may report to the first wireless communications network a preference for a reduced configuration while the UE 102 may report to the second wireless communications network a preference for a configuration that provides improved conditions for communications between the UE 102 and the second wireless communications network, e.g., higher bandwidth, more component carriers, etc.

The at least one condition may comprise a change of data demands in at least one of the first and second wireless communications networks. For example, while there may be a low data demand for one of the wireless communications networks, e.g., the first wireless communications network, the UE 102 may report to the first wireless communications network a preference for a reduced configuration, while the UE 102 may report to the second wireless communications network a preference for a configuration that provides improved conditions for communications between the UE 102 and the second wireless communications network, e.g., higher bandwidth, more component carriers, etc.

The first request to the first network node 104 may be provided in response to an expiration of a timer that determines when the UE 102 can send requests to the first and/or second network nodes. For example, the timer may be a timer to prohibit frequent reports sent by the UE 102, such that the UE 102 can only send another report, such as a UE assistance information, or a trigger once the timer expires. The timer may operate with any suitable frequency, and the timer may be adjustable. Once a UE assistance information or a trigger indication is set, the timer may be reset.

The first request to the first network node 104 may be provided in response to one or more out of:
availability of information to be sent in the first request that is different from information previously sent in a prior request to the first network node 104 concerning a reduced set of capabilities;
an occurrence of an event;
an occurrence of network configured conditions;
a handover of the UE 102 from a source cell to a target cell;
a reconfiguration procedure other than a handover;
a connection setup;
a re-establishment procedure;
a resume procedure; and
an indication that the UE is to be suspended.

The first request may be provided based on the availability of information to be sent in the first request that is different from information previously sent in a prior request to the first network node 104 concerning a reduced set of capabilities. Providing different information may be a condition to send a subsequent report, i.e. if the UE 102 has already sent a report concerning reduced UE configuration for Multi-USIM purposes, the UE 102 may only send another report if such report concerns different information compared to the previous report. The report may be a UE assistance information and/or a trigger indication.

The first request may be provided based on an occurrence of an event, or a cause value. For example, the UE 102 may send a report concerning a reduced UE configuration for Multi-USIM purposes if the report is triggered by a certain event or cause, such as e.g. low battery, a certain traffic level, etc.

The first request may be provided during a handover of the UE 102 from a source cell to a target cell. For example, the first request may be provided right after the handover (reconfiguration with sync) to the target cell. The UE 102 may indicate preference for a reduced UE configuration for Multi-USIM purposes to the target cell. The first request to the first network node 104 may be provided in response to sending a UE assistance information message that no longer includes an indication of UE preference for a certain reduced UE configuration/capabilities for MUSIM purposes.

The first request to the first network node 104 may be provided when the UE 102 initiates an RRC connection reestablishment procedure or when the UE 102 initiates a RRC resume procedure. The configuration related with assistance information on reduced UE configuration for Multi-USIM purposes may be released by the UE 102.

The first request to the first network node 104 may be provided if UE assistance information is sent that no longer includes an indication of UE preference for a certain reduced UE configuration/capabilities for Multi-USIM purposes. For example, if the UE 102 has sent a UE assistance information to a network node with an indication of UE preference to have reduced multiple input multiple output (MIMO) layers, the transmission of a new UE assistance information message where this indication, of UE preference to have reduced MIMO layers, is not present corresponds to no longer having a preference on reduced MIMO layers.

The UE assistance information may be provided to the UE 102 in the first request, or as the first request.

The UE assistance information may be provided to the first network node 104 before triggering the first request to the first network node 104. In other words, the UE assistance information, related to reduced capabilities of the UE 102 for MUSIM purposes, may be sent by the UE 102 to the first network node 104 in advance. In such embodiments, the UE assistance information, which may be stored in the first network node 104, may be activated using a trigger indication, also referred to herein as an activation request, such as, e.g., a lower-layer trigger indication, which the UE 102 may send to the first network node 104. Thus, the UE assistance information related to the set of capabilities may be stored in the first network node 104, and triggering the first request comprises sending a lower-layer trigger indication to the first network node 104 to activate the UE assistance information to disable the set of capabilities. In such embodiments, the first request may comprise the trigger indication, such as a lower-layer trigger indication.

The lower-layer trigger indication may comprise a medium access control (MAC) control element (CE) trigger indication or an uplink control information (UCI) trigger indication. In some embodiments, one or both the MAC CE trigger indication and an UCI trigger indication may be a single bit or a bitmap.

The UE assistance information may include one or more carrier frequencies, e.g., a list of carrier frequencies and/or carrier frequency combinations, that are not to be used as compared to carrier frequencies in the one or more capabilities of the UE 102 provided to the first network node 104. For example, if the UE 102 indicates carriers f2, f3, f4, and f5 as potentially affected carriers to the first wireless communications network, a configuration may include 4 entries. A corresponding field is also defined for MAC CE or UCI, i.e., 4 bits may be reserved to indicate those carriers, so the first bit corresponds to f2, the second bit corresponds to f3, the third bit corresponds to f4, and the fourth bit corresponds to f5. Thus, if some services in the second wireless communications network require the use of f4, a MAC CE or UCI may be sent to the first network node 104 (and thus to the first wireless communications network), where the third bit corresponding to carrier f4 is set to 1 or to another suitable value. In this way, the UE 102 informs the first network node 104 that the first network node 104 should not configure f4 for communications between the UE 102 and the first network node 104.

The UE 102 may receive an RRC reconfiguration for full capabilities from the first network node 104. Some parts of the full capabilities may be subject to upgraded/downgraded UE configuration and are indicated as such, e.g., configuration for carriers f2, f3, f4, and f5 or MIMO layers. The configurations are further provided with an indication whether these are to be immediately applied or not. If the configuration is not to be immediately applied, the UE 102 only the information on the RRC reconfiguration and waits for a trigger indication, such as, e.g., a lower layer indication, to apply the RRC reconfiguration, where the configurations for f2, f3, f4, and f5 are then applied.

When the first network node 104 receives the UE assistance information from the UE 102 that f4 is the affected carrier, plus the lower-layer trigger indication, the first network node 104 may send a MAC CE or downlink control information (DCI) with the 3rd bit corresponding to f4 set to 1 or another suitable value, such that the UE 102 will deconfigure and no longer use that carrier.

When the first network node 104 uses DCI for indicating UE (re)configuration, a new field may be introduced to refer to indexes in the MUSIM related RRC Reconfiguration message. As an example, a new MAC CE or DCI where the 3rd bit is set back to 0, after the 3rd bit was set to 1, indicates that the UE 102 can revert the deconfiguration, i.e., the UE 102 uses an upgraded RRC configuration.

Action 208. The UE 102 may receive a reconfiguration message. The UE 102 may receive an RRC reconfiguration message and/or a lower-layer indication from the first network node 104 when the first network node 104 accepts the first request and disables the set of capabilities.

Action 210. The UE 102 may receive a rate adaptation instruction. The UE 102 may receive the rate adaptation instruction from the first network node 104 when the first network node 104 accepts the first request and disables the set of capabilities. The rate adaptation instruction may comprise a recommendation for the UE 102 to temporarily reduce a bitrate in one or both an uplink and downlink.

Action 212. The UE 102 may trigger adaptation or downgrading of ongoing services to a lower service quality when the first network node 104 accepts the first request and disables the set of capabilities.

Action 214. The UE 102 may connect to the second network node 106 and use the set of capabilities for a service once the first network node 104 accepts the first request and disables the set of capabilities, such that the UE 102 is connected to the first network node 104 with reduced capabilities without the set of capabilities, and the UE 102 is connected to the second network node 106 using the set of capabilities, for example, reduced capabilities comprising the set of capabilities.

Once the first network node 104 accepts the first request and disables the set of capabilities which are reduced capabilities as compared to the capabilities in the first information sent to the first network node 104, the UE 102 may be configured with the reduced capabilities. The UE 102 may use certain capabilities, which are released for use in connecting to the second network node 106, to connect to the second network node 106. Thus, at this point, the UE 102 is connected to both the first and second wireless communications networks, such that the UE 102 now is in RRC_CONNECTED mode in both first and second networks. The service(s) between the UE 102 and the first network node 104 continue with the reduced capabilities, and the UE 102 uses one or more services at the second network node 106. When the UE is connected to both the wireless communications networks, the used capabilities may be reduced in both wireless communications networks.

After some times has passed, the one or more services between the UE 102 and the second network node 106 may end, such that the UE 102 disconnects from the second network node 106. Thus, the UE 102 may be in the RRC_CONNECTED mode in the first wireless communications network, and the UE 102 may be in the RRC_IDLE mode or the RRC_INACTIVE mode in the second wireless communications network.

Furthermore, in some embodiments, rather than disconnecting from the second network node 106 and going into an RRC_INACTIVE mode in the second wireless communications network, it may be desirable not to remove the second network node 106. Instead, a semi/sleeping dual connectivity (DC) may be created, so that, when the UE 102 connects to the second network node 106 again later, the UE 102 can avoid the procedure to setup the network node. In this way, latency may be reduced. As another variation, the UE 102 may instruct the second network node 106 to deactivate the second network node 106, e.g., a secondary cell group (SCG) and enters a semi-RRC_INACTIVE mode.

Action 216. The UE 102 may trigger a second request to the first wireless communications network to reenable the set of capabilities or a portion thereof. In some embodiments, when the UE 102 disconnects from the second network node 106 and continues to be connected to the first network node 104 using the reduced capabilities, the UE 102 triggers the second request to the first network node 104 to reenable at least a portion of the set of capabilities for communication with the first network node 104. It should be noted that, throughout this disclosure, a description of reenabling the set of capabilities comprises reenabling at least a portion of the set of capabilities.

The second request may comprise a UE assistance information, which may be similar to the UE assistance information discussed above in connection with the first request. The second request may comprise a UE assistance information, such that the UE 102 provides the UE assistance information to the second network node 106.

The UE assistance information may comprise one or more of: an indication in an IDC assistance information, an indication in the IDC assistance information in combination with a multiple SIM, MUSIM, indication, and MUSIM assistance information.

The UE assistance information may be provided to the second network node 106 in advance and it may be stored in the second network node 106. The UE assistance information may then be activated, e.g., in response to a trigger indication. In such embodiments, the second request may comprise the trigger indication, such as a lower-layer trigger indication.

Action 218. The UE 102 may receive a reconfiguration message, such as e.g., a second reconfiguration message. The UE 102 may receive an RRC reconfiguration message and/or a lower-layer indication from the first network node 104 when the first network node 104 accepts the second request and reenables at least a portion of the set of capabilities. The lower-layer indication may comprise a MAC CE indication or a DCI/uplink control information (UCI) indication.

Action 220. The UE 102 may receive a second rate adaptation instruction. The UE 102 may receive the second rate adaptation instruction from the first network node 104 when the first network node 104 accepts the second request and reenables at least a portion of the set of capabilities. In some embodiments, the second rate adaptation instruction may comprise a recommendation for the UE 102 to increase the bitrate in one or both an uplink and downlink.

Action 222. The UE 102 may trigger adaptation or upgrading of ongoing services to a higher service quality when the first network node 104 accepts the second request.

Action 224. The UE 102 may further revert to using at least a portion of the (reenabled) set of capabilities of the one or more first capabilities from the first information to connect to the first network node 104 once the first network node 104 accepts the second request and reenables the at least a portion of the set of capabilities.

When the first network node 104 accepts the second request, the first network node 104 may reenable the entire set of the previously disabled capabilities, or it may reenable a portion, or subset, of the previously disabled capabilities.

A dynamic activation/deactivation of connection of the UE 102 to one or both the first and second wireless communications networks may be performed, in order to achieve a desired utilization of the network resource which can be enhanced to support the dynamic update due to, e.g., the UE notification in MAC layer.

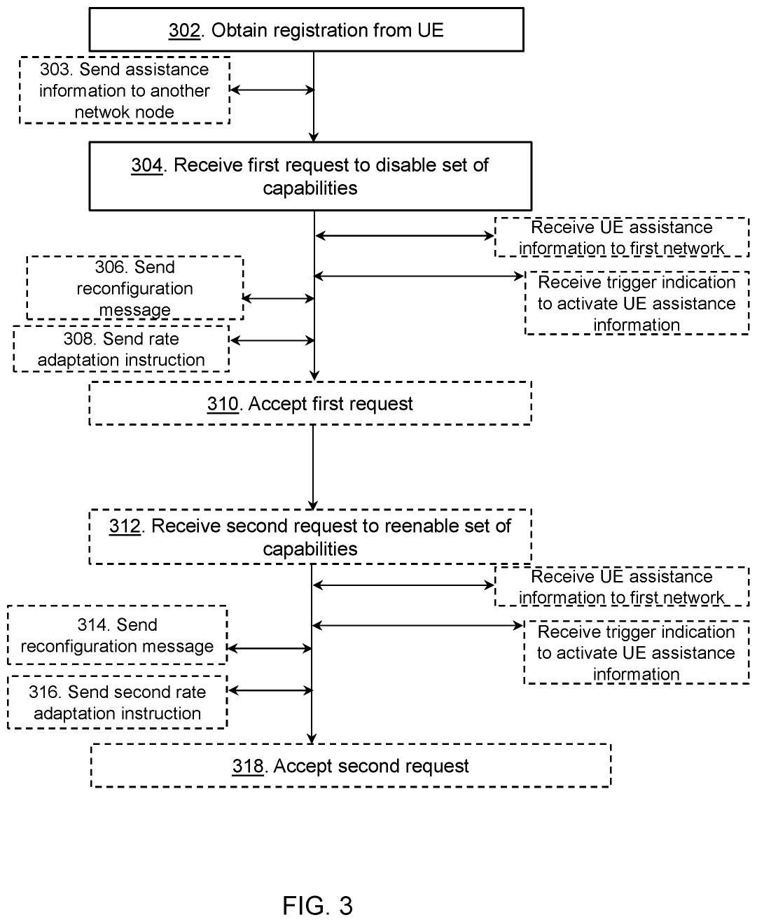

FIG. 3 illustrates an example of a method performed by a first network node associated with a wireless communications network, such as any of the first and second network nodes 104, 106, associated with first and second wireless communications networks 140, 160, respectively, in accordance with embodiments of the present disclosure. Any suitable network node may communicate with a UE, such as the UE 102, in accordance with embodiments of the present disclosure. Optional actions are shown using a dashed line. The acts in FIG. 3 may be performed in any suitable order.

The first network node may be associated with the first wireless communications network associated with the first SIM.

Action 302. The first network node obtains a registration from the UE 102. The first network node obtains a registration, with the wireless communications network associated with the first SIM, by receiving, from the UE 102, first information comprising one or more first capabilities of the UE 102. The UE 102 is simultaneously registered with the first wireless communications network and at least one second wireless communications network associated with the second SIM. For example, the UE 102 may be simultaneously registered with the first and second wireless communications networks.

The one or more first capabilities of the UE 102 may comprise UE capabilities relevant to the first wireless communications network. The first information may comprise the one or more first capabilities of the UE 102 and may comprise information on full capabilities of the UE 102.

The first network node may obtain the registration from the UE 102 by configuring the UE 102 based on the received first information on the one or more first capabilities of the UE.

The first network node may configure the UE 102 to provide UE assistance information to the first network node concerning reduced UE configuration for Multi-USIM purposes. The first network node may decide to configure the UE 102 to provide such information based on the awareness that the UE 102 is a Multi-USIM UE.

Depending on the assistance information provided by the UE 102, the first network node may take its own actions and reconfigure the UE, e.g. activate or deactivate secondary cells (SCells).

Action 303. The first network node may generate its own assistance information report to be sent to another node, and the first network node may send that assistance information to another network. The assistance information may be generated based on the reception of the UE assistance information. The assistance information generated by the first network node may be sent to another node, for example, for handover/Retrieve UE Context. A source node/serving node may forward the received assistance information, and additionally include source node generated information that may be relevant for the target node.

Action 304. The first network node receives the first request to disable the set of capabilities. The first network node receives the first request to disable the set of capabilities from the one or more first capabilities in the first information comprising the one or more first capabilities of the UE 102, when the UE 102 is connected to the first wireless communications network and uses the one or more first capabilities from the first information for a service. The UE 102 may be disconnected from the second wireless communications network.

The first request may comprise a UE assistance information.

The UE assistance information may comprise one or more of: an IDC assistance information; an indication in the IDC assistance information in combination with a multiple SIM, MUSIM, indication; and a MUSIM assistance information. In some embodiments, the MUSIM assistance information is separated from the IDC assistance information and the IDC assistance information is not modified due to MUSIM.

The first network node may receive the first request, which may comprise the UE assistance information, in response to occurrence of various events and in various circumstances which are discussed above in connection with FIG. 2 (act 206) and which are discussed elsewhere herein. For example, in the event of:
availability of information to be sent in the first request that is different from information previously sent in a prior request to the first network node 104 concerning a reduced set of capabilities;
an occurrence of an event;
an occurrence of network configured conditions;
a handover of the UE 102 from a source cell to a target cell;
a reconfiguration procedure other than a handover;
a connection setup;
a re-establishment procedure;
a resume procedure; and
an indication that the UE is to be suspended.

The first network node may receive the UE assistance information before the first request is received by the first network node. In such embodiments, the UE assistance information, related to reduced capabilities of the UE 102 for MUSIM purposes, may be received by the first network node in advance. In these embodiments, the UE assistance information, which may be stored in the first network node, may be activated at the first network node (so that the network node (re)configures the UE 102 based on the UE assistance information) using a trigger indication, also referred to herein as an activation request. The trigger indication may be, e.g., a lower-layer trigger indication, which the network node receives from the UE 102, e.g., as part of the first request. Thus, in some embodiments, the UE assistance information related to the set of capabilities is stored in the first network node, and receiving the first request comprises receiving a lower-layer trigger indication to the first network node to activate the UE assistance information to disable the set of capabilities. The first request may comprise the trigger indication, such as a lower-layer trigger indication.

The lower-layer trigger indication may comprise a MAC CE trigger indication or a UCI trigger indication. In some embodiments, one or both the MAC CE trigger indication and an UCI trigger indication may be a single bit or a bitmap.

Action 306. The first network node may send a reconfiguration message to the UE 102. The first network node may send an RRC reconfiguration message and/or a lower-layer indication when accepting the first request and disabling the set of capabilities for communication with the UE 102. The lower-layer indication may comprise a MAC CE indication or a DCI/UCI indication.

Action 308. The first network node may send the rate adaptation instruction to the UE 102. The first network node may send the rate adaptation instruction to the UE 102 when accepting the first request and disabling the set of capabilities for communication with the UE 102.

The sending of the rate adaptation instruction to the UE 102 may comprise one or more out of:
providing a recommendation for the UE to temporarily reduce a bitrate in one or both an uplink and downlink;
triggering a renegotiation of an ongoing communication session with the UE;
terminating at least one session with the UE.

When the one or more first capabilities of the UE 102 for communications with the first network node are reduced, in some embodiments, it may be beneficial to trigger rate adaptation for the application or services that are ongoing in the wireless communications network, such as a RAN. For example, in applications or services using high bitrates, high quality video and virtual reality (VR), it may be useful to trigger rate adaptation since the service quality may suffer if the available bandwidth is reduced. Depending on how many sessions/services, and what type of sessions/services, that are ongoing, this can be done in several ways, for example:
1. The first network node may send a bitrate recommendation, e.g., the Recommended bitrate MAC CE [3GPP TS 38.321, clauses 5.18.10 and 6.1.3.20], to the UE to temporarily reduce the bitrate in either uplink or downlink (or both).
2. The first network node may trigger a renegotiation of the ongoing session. The first network node may have pre-configured configuration and indicate an index which are comprehended by both UE and the first network node. The first network node, or the network, can learn from the traffic model, using UE expected behavior information, etc., and predict the needed bitrate configuration pattern.
3. The first network node may terminate at least one session from the ongoing sessions to keep other sessions alive with maintained service quality.

Action 310. The first network node may accept the first request. The first network node may accept the first request and may disable the set of capabilities for communication with the UE 102, such that the UE 102 is connected to the first wireless communications network with reduced capabilities without the set of capabilities, and the UE 102 may be connected to the second wireless communications network with one or more capabilities of the set of capabilities.

It should be appreciated that accepting the first request may involve processes in one or both of actions 306 and 308, as these actions are shown as separate acts for description purposes only.

Action 312. The first network node may receive the second request to reenable the set of capabilities or a portion thereof. When the UE 102 disconnects from the second wireless communications network and continues to be connected to the first wireless communications network using the reduced capabilities, the first network node may receive from the UE 102 the second request to reenable at least a portion of the set of capabilities for communication with the first wireless communications network.

Action 314. The first network node may send a reconfiguration message to the UE 102. The first network node may send an RRC reconfiguration message and/or a lower-layer indication when accepting the second request and reenabling at least a portion of the set of capabilities for communication with the UE 102. The lower-layer indication may comprise a MAC CE indication or a DCI/UCI indication.

Action 316. The first network node may send the second rate adaptation instruction to the UE 102. The first network node may send the second rate adaptation instruction to the UE 102 when accepting the second request and reenabling at least a portion of the set of capabilities for communication with the UE 102. The second rate adaptation instruction may comprise a recommendation for the UE to increase the bitrate in one or both the uplink and downlink.

When the capabilities are restored, and if the bitrate has been previously reduced, which may be temporary, the first network node (and/or a RAN) may send a new bitrate recommendation to allow applications/services to increase their bitrate again. The first network node may trigger an upgrade of a service that has been previously renegotiated to a lower service quality. Thus, in some embodiments, the first network node may trigger an upgrade of a service that has been renegotiated to a lower service quality when accepting the second request and reenabling at least a portion of the set of capabilities for communication with the UE 102.

Action 318. The first network node may accept the second request and may reenable the set of capabilities, or at least a portion thereof, for communication with the UE 102 to thereby allow the UE 102 to revert to using at least a portion of the set of capabilities from the first information comprising one or more first capabilities of the UE 102 to connect to the first wireless communications network. Thus, the first network node may reenable at least a portion of the previously disabled capabilities from the set of capabilities.

It should be appreciated that accepting the second request may involve processes in one or both of actions 314 and 316, as these actions are shown as separate acts for description purposes only.

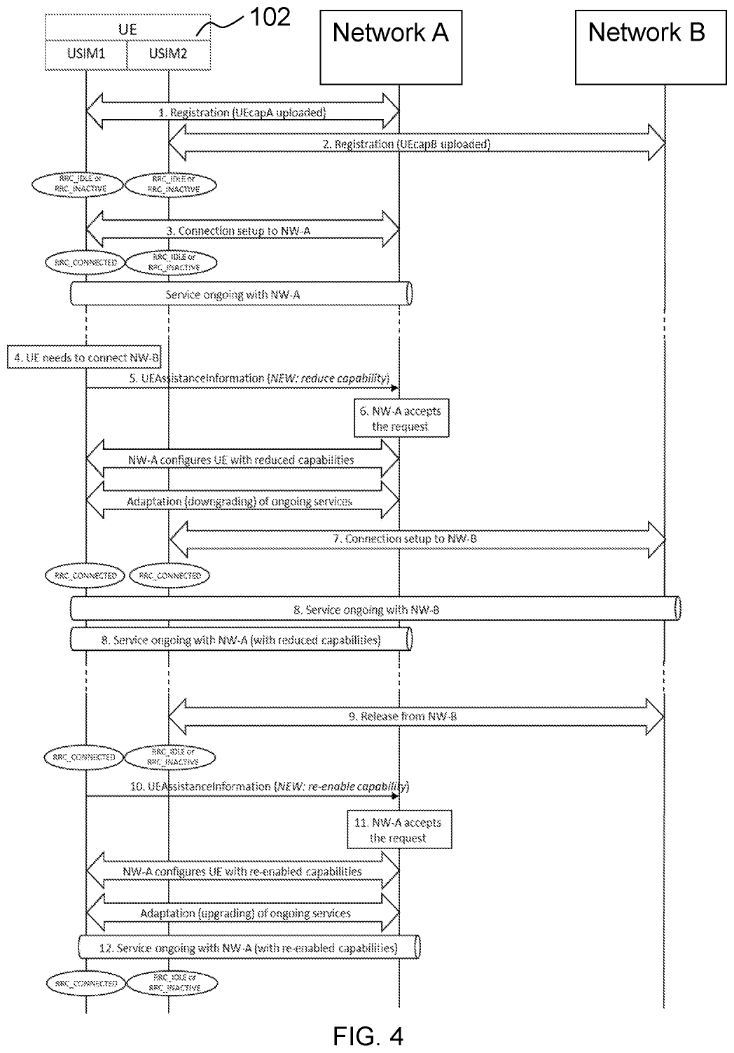

FIG. 4 illustrates a signalling scheme showing communications between the UE 102 and first and second network nodes, in accordance with some embodiments. For illustration purposes only, first and second network nodes, e.g., first and second network nodes 104 and 106, are associated with network A and network B, respectively, and the method is described with reference to networks A and B. In the example illustrated, network A and network B may be referred as two networks, where a Multi-USIM UE is simultaneously in RRC_CONNECTED. It should be appreciated however that the communications as shown in FIG. 4, and as described elsewhere herein, are also applicable to a case where the UE is connected to more than two wireless communications networks. A person skilled in the art will appreciate how the methods in accordance with embodiments of the present disclosure may be performed in scenarios with more than two wireless communications networks.

As shown in FIG. 4, the UE, such as the UE 102, may have multiple USIMs. In some embodiments, the different USIMs are associated with different wireless communications networks, where a wireless communications network may be a PLMN or a non-public network (NPN). Furthermore, in some embodiments, a UE has more than one USIM which is associated with the same wireless communications network, e.g. a UE has two SIMs from the same operator. In the example of FIG. 4, multiple SIMs, such as USIM1 and USIM2 are associated with different wireless communications networks, but the methods in accordance with embodiments of the present disclosure may also be applied to implementations where multiple USIMs are associated with the same wireless communications network.

The numbered exemplary actions shown in FIG. 4 are described below:
1. The UE 102 registers to Network A (“Registration (UecapA uploaded)”).
   a. UE 102 uploads UE capabilities relevant for Network A (UecapA) to Network A.
   b. Network A configures UE 102 according to the provided UE capabilities.
2. The UE 102 registers to Network B (“Registration (UecapB uploaded)”).
   a. UE 102 upload UE capabilities relevant for Network B (UecapB) to Network B.
   b. Network B configures UE 102 according to the provided UE capabilities.
The UE 102 is registered in the two Networks and the relevant UE capabilities have been provided.
It should be appreciated that the act (2) can be performed before the act (1).
Before a connection setup begins, the UE 102 is in the RRC_IDLE or RRC_INACTIVE state in Network A and Network B.
3. The UE 102 may start service(s) in Network A.
   a. The UE 102 is in RRC_CONNECTED mode only in Network A (and the UE 102 is in RRC_IDLE/RRC_INACTIVE state in Network B).
It should be appreciated that the act (3) can be performed before the act (2).
There is an ongoing service with Network A, as shown in FIG. 4.
After some time passes, the UE 102 may need to connect to Network B.
4. The UE 102 may connect to Network B.
5. The UE 102 sends a request comprising, in this example, UE assistance information (“UEAssistanceInformation (NEW: reduce capability)”) to Network A, requesting that certain capabilities are (temporarily) disabled.
6. Network A may accept the request and disables (possibly temporarily) certain capabilities.
   a. Network A can use RRC Reconfiguration procedure or lower layer means, e.g., MAC CE/DCI indication, to configure the UE 102 with reduced capabilities (“NW-A configures UE with reduced capabilities”).
   b. Network A or the UE 102 may trigger adaptation (downgrading) for ongoing services in Network A (“Adaptation (downgrading) of ongoing services”).
7. The UE 102 may use certain capabilities to connect to Network B (“Connection setup to NW-B”).
   a. The UE 102 now is in RRC_CONNECTED mode in both networks.
8. Service(s) between UE 102 and Network A may continue with reduced capabilities (“Service ongoing with NW-B” and “Service ongoing with NW-A (with reduced capabilities)”).
After some time passes, the service(s) between the UE 102 and Network B may end.
9. Services between the UE 102 and Network B may be ended, and UE 102 disconnects from Network B (“Release from NW-B”).
   a. The UE 102 is now in RRC_CONNECTED mode in Network A and in RRC_IDLE or RRC_INACTIVE in Network B.
10. The UE 102 may further send UE assistance information to Network A requesting that the certain capabilities are reenabled (“UEAssistanceInformation (NEW: reenable capability)”).
11. Network A may accept the UE request and reenables the previously disabled capabilities or may reenable a subset, e.g., at least a portion, of those capabilities.
   a. Network A can use RRC Reconfiguration or lower layer means, e.g., MAC CE/DCI indication, to reconfigure the UE 102 with re-enabled capabilities “NW-A configures UE with re-enabled capabilities”.
   b. Network A or the UE 102 may trigger adaptation (upgrade) for ongoing services in Network A (“Adaptation (upgrading) of ongoing services”).
12. The UE 102 and Network A may then continue using full capabilities (“Service ongoing with NW-A (with re-enabled capabilities)”).
   The UE 102 is in RRC_CONNECTED mode in Network A and in RRC_IDLE or RRC_INACTIVE in Network B.

The procedure in FIG. 4 describes the case when the UE 102 stays in RRC_CONNECTED mode in Network A the entire time and may connect to Network B for a short time. It should be appreciated that the same or similar procedure applies in the case that the UE starts in RRC_CONNECTED mode in Network B and then connects to Network A. It should also be obvious that the same procedure applies for a UE that is in RRC_CONNECTED mode in both wireless communications networks and then leave Network A instead of leaving Network B.

### RRC Configuration.

The first network node may (re)configure the UE 102 for communications with the first network node, and with the network with which the network node is associated. An RRC configuration message may be received by the UE.

In some embodiments, triggering RRC reconfigurations may be performed in a more dynamic manner, e.g., the RRC message may be sent in advance, but needs to be activated by lower layers, e.g., by a MAC CE (defined in TS 38.213) or DCI/UCI (defined in TS 38.212) indication, i.e., the UE assistance information is only applicable when indicated so by lower layers.

For the MAC CE option, at least one new MAC CE, e.g. MUSIM assistance information (AI) activation/deactivation MAC CE, is introduced for the uplink in 3GPP TS 38.321. This also requires a definition of a corresponding Logical Channel Identifier (LCID).
Aᵢ: If there is an MUSIM assistance information configured for the MAC entity with AI-Index i as specified in the RRC message, this field indicates the activation/deactivation status of the assistance information element with AI i, else the MAC entity shall ignore the Aᵢ field. The Aᵢ field is set to 1 to indicate that the with Assistance information element with AI-Index i shall be activated. The Aᵢ field is set to 0 to indicate that the Assistance information element with AI-Index i shall be deactivated;
R: Reserved bit, set to 0.

| | | | | | | | | |
|---|---|---|---|---|---|---|---|---|
| A₇ | A₆ | A₅ | A₄ | A₃ | A₂ | A₁ | R | Oct 1 |

It should be appreciated that values other than 0 and 1 may be used in some embodiments.

Thus, in some embodiments, e.g., in action (5) of FIG. 4, the UE assistance information related to reduced capabilities for MUSIM may be sent by the UE 102 in advance. The network node may thus store the information, but does not consider the information to be valid yet. The request, such as the first or second request, is activated when the UE 102 sends the MUSIM AI MAC CE or an indication in UCI. In some embodiments, this may be a single bit or even a bitmap.

The UE 102 may provide, in the UE assistance information, AffectedCarrierFreqList and/or AffectedCarrierFreqCombList. The UE may indicate carriers f2, f3, f4, and f5 as “potentially” affected carriers for network A. The configuration contains 4 entries. A corresponding field is also defined for MAC CE or UCI, i.e., 4 bits would be reserved to indicate those carriers, so the first bit corresponds to f2, the second bit corresponds to f3, and so on. Thus, if some services in network B require the use of f4, a MAC CE or UCI would be sent to network A, where the 3^{rd} bit corresponding to carrier f4 is set to 1. And network A thus knows that it should not configure f4.

Similarly, the first network node may in a first step send an RRC reconfiguration for full capabilities and some parts may be subject to upgraded/downgraded UE configuration and are indicated as such, e.g., configuration for carriers f2, f3, f4, and f5 or MIMO layers. The configurations are further provided with an indication whether these should be immediately applied or not. If the configuration should not be immediately applied, the UE 102 may only store the information and may wait for lower layer indications to apply the RRC reconfiguration, where the configurations for f2, f3, f4, and f5 are then applied.

When the network A receives the UE assistance information from the UE 102 that f4 is an affected carrier, plus the lower layer trigger, network A sends a MAC CE or DCI with the 3^{rd} bit corresponding to f4 set to 1, such that the UE would de-configure and no longer use the carrier.

In some embodiments in which a DCI indication is used, a new may be introduced to refer to the indexes in the MUSIM related RRC Reconfiguration message.

A new MAC CE or DCI where the 3^{rd} bit is set back to 0 means that the UE 102 can revert the deconfiguration, i.e. it uses the upgraded RRC configuration as before.

The UE assistance information with lower layer triggers to activate is simple to apply. The RRC reconfiguration with activation trigger may require more memory in the UE 102 as the UE 102 potentially has to store different versions of the RRC reconfiguration for the downgrade and upgrade, which may thus increase the UE complexity.

Further description of some of UE aspects is provided below, in accordance with embodiments of the present disclosure.

### Description of One or More UE Aspects.

The UE aspects in accordance with embodiments herein focus on triggering aspects for the UE indication. Example content of such indication and other related aspects are described below.

The UE 102 may be configured to provide UE assistance information to the first network node concerning a preference for reduced UE configuration for Multi-USIM purposes. In some embodiments, such assistance information and/or activation requests may be triggered, or prevented to be triggered, by any of following:
Change of UE conditions on each Network it is connected. Depending on different aspects related to each network the UE 102 is connected, the UE 102 may decide to trigger a UE assistance information report or trigger to send an activation request for one or more elements provided in the UE assistance information, those different aspects include any of:
a. Channel conditions in at least one of the networks the UE is connected. For instance, the channel conditions for Network A may have become worse while they were improved for Network B, hence the UE 102 may report, to Network A, a preference for reduced configuration while it may report for Network B a preference for a “better” configuration (higher bandwidth, more component carriers, etc.).
b. Change of data demands in at least one of the networks the UE 102 is connected. For instance, while there is low data demand for Network A, the UE 102 may report, to Network A, a preference for reduced configuration while it may report for Network B a preference for a “better” configuration (higher bandwidth, more component carriers, etc.).
A timer to prohibit frequent reports sent by the UE 102, i.e., the UE can only send another report or trigger once the timer expires.
Providing different information as a condition to send a subsequent report, i.e., if the UE 102 has already sent a report concerning reduced UE configuration for Multi-USIM purposes, it can only send another report if it concerns different information compared to the previous report.
Report based on cause value, i.e. the UE 102 can only send a report concerning reduced UE configuration for Multi-USIM purposes if the report is triggered by specific cause e.g. low battery, traffic level, etc.
Network configured conditions, which could include any of the other conditions listed here.
During a handover, e.g., right after the handover (reconfiguration with sync) to a target cell the UE 102 indicates the preference of reduced UE configuration for Multi-USIM purposes to the target cell.
During a reconfiguration procedure other than a handover.
During a connection setup, e.g. after security is established.
During a re-establishment procedure.
During a resume procedure.
Before the UE is suspended.
For the UE 102 that is configured to provide assistance information on reduced UE configuration/capabilities for Multi-SIM purposes, when the UE 102 initiates RRC connection re-establishment procedure or when the UE initiates a RRC resume procedure, the configuration related with assistance information on reduced UE configuration for Multi-USIM purposes is released by the UE.
If sending a UE assistance information message that no longer includes an indication of UE preference for a certain reduced UE configuration/capabilities for Multi-USIM purposes. As an example, if the UE 102 has sent a UE assistance information message to the network with an indication of UE preference to have reduced MIMO layers, the transmission of a new UE assistance information message where this indication (of UE preference to have reduced MIMO layers) is not present corresponds to no longer having a preference on reduced MIMO layers.

Description of Network Aspects. Further description of some of network, and/or network node, aspects is provided below, in accordance with various embodiments of the present disclosure.

This section focuses on network actions executed before and after the reception of the UE indications.
A. A first network node can configure the UE 102 to provide UE assistance information to the first network node concerning reduced UE configuration for Multi-USIM purposes. The first network node may decide to configure the UE 102 to provide such information based on the awareness that the UE 102 is a Multi-USIM UE.
B. Based on the reception of the UE assistance information report from the UE 102, the first network node may take the following action:
   1. Generate its own assistance information report to be sent to another node (e.g. for handover/Retrieve UE Context, a source node/serving node may forward the received UE report, and additionally include source node generated information that may be relevant for the target node).

Depending on the assistance information provided by the UE 102, the first network node can take own actions and reconfigure the UE 102, e.g., activate or deactivate secondary cells (Scells).
C. When the capabilities are reduced, it is (at least in some cases) beneficial to trigger rate adaptation for the application or the services that are ongoing in Network A. This may be particularly useful for, e.g, applications or services using high bitrates, high quality video and VR, since the service quality may suffer if the available bandwidth is reduced. Depending on how many sessions/services, and what type of sessions/services, that are ongoing, this can be done in several ways, for example:
   1. RAN can send a bitrate recommendation, e.g., the Recommended bitrate MAC CE [3GPP TS 38.321, clauses 5.18.10 and 6.1.3.20], to the UE 102 to temporarily reduce the bitrate in either uplink or downlink (or both).
   2. RAN can trigger re-negotiation of the ongoing session. RAN can have pre-configured configuration and indicate an index which are comprehended by both UE and the network; The network can learn from the traffic model, using UE expected behavior information, etc. and predict the needed bitrate configuration pattern.
   3. RAN can terminate some sessions to keep other sessions alive with maintained service quality.
   4. The UE 102 may also itself trigger adaptation or downgrading of ongoing services to a lower service quality.
D. When the capabilities are restored, and if the bitrate has been temporarily reduced (see E, below) then RAN can send a new bitrate recommendation to allow applications/services to increase their bitrate again.
   1. In some cases, RAN may trigger an upgrade of a service that has been renegotiated to a lower service quality.
   2. The UE 102 may also itself trigger adaptation or upgrading of ongoing services to a higher service quality.
E. The dynamic activation/deactivation of the dual connectivity (DC), in order to achieve the desired utilization of the network resource can be enhanced to support the dynamic update due to e.g. the UE notification in MAC layer.

The UE, network nodes, and methods according to embodiments herein are applicable in various implementation environments.

In some embodiments, the information, e.g. about the UE behavior/traffic pattern/UAI may be conveyed from the network A to the network B. For example, the information can be included in a transparent container and passed from one network to another via CN. The network node, upon the reception of such information, may make a more informed decision regarding pre-configuring and predicting.

In some embodiments, if DC is configured for the Multi-SIM UE, when UE 102 goes into RRC_INACTIVE mode, it may be desirable not to remove a network node such as, e.g., a secondary node (SN). Instead, a “semi/sleeping” DC state may be created, so that, when the UE 102 is back to DC later, it can avoid the procedure to setup the first network node and thus reduce latency. 5G gNB upon E-UTRAN New-Radio Dual-Connectivity (EN-DC) activation is referred to as Secondary Node (SN). Alternatively, the network may be instructed to deactivate a secondary cell group (SCG) and goes to semi RRC_INACTIVE.

In some embodiments, a request that certain capabilities of the UE be reduced, may be provided, from the UE 102 to the network, using an IDC assistance information.

With the increasing demand to have seamless data connectivity to several wireless networks, many devices or UEs are designed to support different radio access technologies (RAT) for parallel usage. In order to support this parallel operation, the UEs are equipped with multiple radio transceivers, which are located extremely close to each other. When the different radio technologies operate simultaneously, these transceivers may interfere with each other, resulting in IDC interference. To solve this issue, a UE IDC assistance information was introduced to mitigate the IDC interference for NR Rel-16. Thus, for simultaneous operation, the UE 102 may signal to the NR network a frequency list or a frequency combination list that should be avoided during NR operation. Together with the frequency, the interference direction can be indicated (e.g. NR, other, or both, where “other” radio refers to either the Industrial, Scientific and Medical band (ISM) radio or Global Navigation Satellite Systems (GNSS)), and, together with the frequency combination, the victim system type can be indicated when UL CA is configured. The current victim system types that can be indicated in Rel-16 are GNSS types (gps, glonass, bds, galileo and navIC), WLAN and Bluetooth.

| | |
|---|---|
| IDC-Assistance-r16 ::= | SEQUENCE { |
| affectedCarrierFreqList-r16 | AffectedCarrierFreqList-r16 |

OPTIONAL,

| | |
|---|---|
| affectedCarrierFreqCombList-r16 | AffectedCarrierFreqCombList-r16 |

OPTIONAL,
...
}
AffectedCarrierFreqList-r16 ::= SEQUENCE (SIZE (1.. maxFreqIDC-r16)) OF
AffectedCarrierFreq-r16

| | |
|---|---|
| AffectedCarrierFreq-r16 ::= | SEQUENCE { |
| carrierFreq-r16 | ARFCN-ValueNR, |
| interferenceDirection-r16 | ENUMERATED {nr, other, both, spare} |

}
AffectedCarrierFreqCombList-r16 ::= SEQUENCE (SIZE (1..maxCombIDC-r16)) OF
AffectedCarrierFreqComb-r16

| | |
|---|---|
| AffectedCarrierFreqComb-r16 ::= | SEQUENCE { |
| affectedCarrierFreqComb-r16 | SEQUENCE (SIZE (2..maxNrofServingCells)) |

OF ARFCN-ValueNR OPTIONAL,

| | |
|---|---|
| victimSystemType-r16 | VictimSystemType-r16 |

}

| VictimSystemType-r16 ::= | SEQUENCE { | |
|---|---|---|
| gps-r16 | ENUMERATED {true} | OPTIONAL, |
| glonass-r16 | ENUMERATED {true} | OPTIONAL, |
| bds-r16 | ENUMERATED {true} | OPTIONAL, |
| galileo-r16 | ENUMERATED {true} | OPTIONAL, |
| navIC-r16 | ENUMERATED {true} | OPTIONAL, |
| wlan-r16 | ENUMERATED {true} | OPTIONAL, |
| bluetooth-r16 | ENUMERATED {true} | OPTIONAL, |

...
}

As described above and exemplified below, the existing IDC assistance information may be used to indicate to a network node a reduced capability of the UE 102. The IDC assistance information may be extended with a MUSIM information. For example, an additional indication may be added to the existing IDC assistance information. In some embodiments, the indication that uses the IDC assistance information indicates a direction of IDC interference.

Several example implementations will now be described, in accordance with one or more embodiments of the present disclosure.

### Example Implementation for Services/Same Prioritization for the SIMS.

If the UE 102 has the possibility to support up to six carriers in total, the UE 102 may indicate in its capabilities that it supports six carriers, that the UE 102 indicates the number of carriers in its supported band-combinations. If the UE 102 operates using only one SIM, no IDC assistance information is sent to the serving network. If the UE 102 operates using two SIMs, the UE 102 may indicate to a first network that specific bands/band combinations covering 3 carriers cannot be used, via the IDC assistance information, while indicating to a second network that other bands or band combinations covering 3 carriers cannot be used.

As an example, the UE 102 may support the following carriers: f1a, f1b, f1c, f1d, f2a and f2b. In such a case, equal split of the carriers may not be possible, such that the UE 102 would need to assign all carriers on f1 to SIM1 (IDC for SIM1 indicates f2a and f2b) and all carriers on f2 to SIM2 (IDC for SIM2 indicates f1a, f1b, f1c and f1d), or vice versa, e.g. depending on how many carriers the already active SIM is already using, depending on other criteria, or decided randomly which of the SIMs can be configured with up to 4 carriers, while the other SIM can only be configured with at most 2 carriers.

Example Implementation for Known Services Associated with Each SIM.

The UE 102 may be configured, e.g. by an end user, such that data traffic is preferred/allowed to be communicated only over one SIM, while voice is preferred/allowed to be communicated over another SIM.

According to one aspect of the present disclosure, the UE 102 considers the expected services its SIMs are configured to use, when indicating capabilities for the SIMs. For example, the UE 102 indicates for the SIM which is expected to serve data traffic IDC or MUSIM assistance information to indicate only one frequency/carrier, while the UE 102 indicates that all frequencies/frequency combinations, except one frequency, are affected for the SIM which should serve voice traffic. The benefit with this is that more resources may be used for the data-SIM and hence high throughputs can be achieved for data communication, while, for the voice-SIM, only single carrier operation is used, which likely is sufficient for voice communication.

In principle, it may be considered that the SIM used for voice services would anyway only use one carrier and thus, no IDC assistance information would be needed. However, if the network intends to, e.g., perform load balancing between different carrier frequencies, it needs to know whether the other frequency can be used by the UE 102 or not since the frequency may be configured for the data-SIM already. Thus, the IDC and/or MUSIM assistance information should always be transmitted to avoid operational issues during simultaneous operation of the SIMs.

The UE 102 may, e.g., support the following carriers: f₁ₐ, f_{1b}, f_{1c}, f₂, f₃ₐ and f_{3b} in the frequency bands f₁, f₂, and f₃, respectively. For convenience, it may be assumed that all carriers have the same bandwidth. SIM1 is associate with voice, and SIM2 is associated with data.

If f₁ₐ is used by SIM1, f_{1b} and f_{1c} can no longer be used by SIM2. Same for f₃ₐ and f_{3b}. Thus, to maximize the number of frequencies to be used for SIM2, the UE signals to network 1 which is associated with SIM1 (voice services), that it cannot use f₁ₐ, f_{1b}, f_{1c}, f₃ₐ and f_{3b}. For network 2 being associated with SIM2 (data services), the UE 102 indicates via the IDC and/or MUSIM assistance information that it cannot use f₂.

Thus, only f₂ can be used for SIM1, and f₁ₐ, f_{1b}, f_{1c}, f₃ₐ and f_{3b} can be aggregated for SIM2 in accordance with the UE's supported band combination(s). Accordingly, in some embodiments, the UE 102 indicates to the network, i.e. to the first network node associated with the first wireless communications network, which one or more resources, e.g. carrier frequencies, are not available for use in communication of the UE with the network.

### Additional Information for Limited Capabilities in Multi-SIM Scenarios.

For any of the above approaches to indicate limited capability via the IDC and/or MUSIM assistance information, the UE 102 indicates in the first request that the capability reduction is for multi-SIM operation, such that the network can optimize the UE configuration in accordance with the actual UE capability and the current situation with regard to simultaneous connectivity to multiple networks using different SIMs.

Option 1: Extend IDC Assistance Information with MUSIM Information

This indication can be added directly to the existing IDC assistance information, e.g., by using the spare values, e.g., for the AffectedCarrierFreq IE some more detailed information can be introduced for the interferenceDirection than only ‘nr’. Furthermore, the UE 102 could use one radio for LTE and one for NR, so that ‘nr’ would not be the correct description. Rather, the spare value could be replaced by e.g. ‘musim’, with reference to TS 38.331 (Added matter are underlined):

| | |
|---|---|
| AffectedCarrierFreq-r16 ::= | SEQUENCE { |
| carrierFreq-r16 | ARFCN-ValueNR, |
| interferenceDirection-r16 | ENUMERATED {nr, other, both, musim-r18} |

}

interferenceDirection.

Indicates the direction of IDC interference. Value nr indicates that only NR is victim of IDC interference, value other indicates that only another radio is victim of IDC interference and value both indicates that both NR and another radio are victims of IDC interference, and value musim indicates that the radio used for MUSIM purposes is victim of IDC interference. The other radio refers to either the Industrial, Scientific and Medical band (ISM) radio or Global Navigation Satellite Systems (GNSS) (see TR 36.816 [44]).

Alternatively, a parallel list may be created where a detailed interference direction is given for MUSIM, where a source value corresponds to the current network for which the UE provides IDC assistance information, and a target value corresponds to another network the UE is registered with. The UE includes the same number of entries in interferenceDirection-r18 as provided for affectedCarrierFreqList. For backwards compatibility, the UE sets the interferenceDirection-r16 to value ‘nr’.

| | |
|---|---|
| IDC-Assistance-r16 ::= | SEQUENCE { |
| affectedCarrierFreqList-r16 | AffectedCarrierFreqList-r16 |

OPTIONAL,

| | |
|---|---|
| affectedCarrierFreqCombList-r16 | AffectedCarrierFreqCombList- |

```
r16 OPTIONAL,
  ...,
  [[
  interferenceDirection-r18 ENUMERATED {source, target, both}
OPTIONAL -- Need N
  ]]
}
```

The indication of IDC for UL CA, i.e., affectedCarrierFreqCombList-r16, can also be used on UE capability reduction for multi-SIM operation. For instance, the UE 102 may support the current configuration for DL from both networks in which the UE 102 is in a RRC_CONNECTED mode, but it may not support certain UL CA configuration, given that such UL resources may be in use by one of the networks. Hence, affectedCarrierFreqCombList-r16 may indicate the affected UL CA configuration from the UE 102, or a subset of such configuration, e.g., the UE 102 may be configured with 3 UL serving cells but report only 2 carriers as affected). To account for the multi-SIM operation, a victimSystem Type can be added, e.g., ‘3gpp-musim’ or similar, to indicate that the required capability limitations are caused by multi-SIM operation:

| VictimSystemType-r16 ::= SEQUENCE { | | |
|---|---|---|
| gps-r16 | ENUMERATED {true} | OPTIONAL, |
| glonass-r16 | ENUMERATED {true} | OPTIONAL, |
| bds-r16 | ENUMERATED {true} | OPTIONAL, |
| galileo-r16 | ENUMERATED {true} | OPTIONAL, |
| navIC-r16 | ENUMERATED {true} | OPTIONAL, |
| wlan-r16 | ENUMERATED {true} | OPTIONAL, |
| bluetooth-r16 | ENUMERATED {true} | OPTIONAL, |
| ... | | |
| [[ | | |
| 3gpp-musim-r18 | ENUMERATED {true} | OPTIONAL |
| ]] | | |
| } | | |

Alternatively, the 3gpp-musim-r18 field can also include multiple values to indicate which multi-SIM operation caused interference e.g., Physical Downlink Control Channel (PDCCH) for PDCCH monitoring, paging occasion monitoring, carrier aggregation, etc.

| VictimSystemType-r16 ::= | SEQUENCE { | |
|---|---|---|
| gps-r16 | ENUMERATED {true} | OPTIONAL, |
| glonass-r16 | ENUMERATED {true} | OPTIONAL, |
| bds-r16 | ENUMERATED {true} | OPTIONAL, |
| galileo-r16 | ENUMERATED {true} | OPTIONAL, |
| navIC-r16 | ENUMERATED {true} | OPTIONAL, |
| wlan-r16 | ENUMERATED {true} | OPTIONAL, |
| bluetooth-r16 | ENUMERATED {true} | OPTIONAL, |

```
  ...
  [[
```

| | | |
|---|---|---|
| 3gpp-musim-r18 | 3GPP-MUSIM-r18 | OPTIONAL |

]]
}

| | |
|---|---|
| 3GPP-MUSIM-r18 ::= | SEQUENCE { |
| pdcch-Monitoring | OPTIONAL, |
| po-Monitoring | OPTIONAL, |
| carrierAggregation | OPTIONAL, |

...
}

### Option 2: MUSIM Assistance Information is Introduced and Refers to IDC Information

An alternative option is to provide the indication for MUSIM operation in an information element (IE) within the UE assistance information, i.e., simply on a different level, and then associate the indication with the IDC assistance information.

UEAssistance Information-v1610-Ies ::= SEQUENCE {

| | | |
|---|---|---|
| idc-Assistance-r16 | IDC-Assistance-r16 | OPTIONAL, |
| drx-Preference-r16 | DRX-Preference-r16 | OPTIONAL, |
| maxBW-Preference-r16 | MaxBW-Preference-r16 | OPTIONAL, |
| maxCC-Preference-r16 | MaxCC-Preference-r16 | OPTIONAL, |
| maxMIMO-LayerPreference-r16 | MaxMIMO-LayerPreference-r16 | OPTIONAL, |
| minSchedulingOffsetPreference-r16 | MinSchedulingOffsetPreference-r16 | OPTIONAL, |
| releasePreference-r16 | ReleasePreference-r16 | OPTIONAL, |
| sl-UE-AssistanceInformationNR-r16 | SL-UE-AssistanceInformationNR-r16 | OPTIONAL, |
| referenceTimeInfoPreference-r16 | BOOLEAN | OPTIONAL, |
| nonCriticalExtension | UEAssistanceInformation-v1800-Ies | OPTIONAL |

}
UEAssistanceInformation-v1800-Ies ::= SEQUENCE {

| | |
|---|---|
| musim-Assistance-r18 | MUSIM-Assistance-r18 |

OPTIONAL, -- Need R

| | |
|---|---|
| nonCriticalExtension | SEQUENCE { } |

OPTIONAL
}

| | |
|---|---|
| MUSIM-Assistance-r18 ::= | SEQUENCE { |
| idc-Impact-r18 | ENUMERATED {true} |

OPTIONAL,

| | |
|---|---|
| nonCriticalExtension | SEQUENCE { } |

OPTIONAL
}

However, as the IDC assistance information includes a list of affected carriers and/or affected carrier combinations (affectedCarrierFreqList and affectedCarrierFreqCombList), a 1-bit indication may not provide sufficient granularity. Therefore, a parallel list may be used, where each entry corresponds to the affected carrier or affected carrier combination in the combined list(s). One possible example is provided below:

| | |
|---|---|
| MUSIM-Assistance-r18 ::= | SEQUENCE { |
| idc-ImpactList-r18 | IDC-ImpactList-r18 |

OPTIONAL, -- Need R

| | |
|---|---|
| nonCriticalExtension | SEQUENCE { } |

OPTIONAL
}

| | |
|---|---|
| IDC-ImpactList-r18 ::= | SEQUENCE (SIZE (1..maxIDC-r18)) OF IDC- |

Impact-r18

| | |
|---|---|
| IDC-Impact-r18 ::= | SEQUENCE { |
| idc-Impact | ENUMERATED {true} |

OPTIONAL
}

The IE dedicated for multi-SIM may also instantiate the ones defined in Rel-16 for IDC. In this manner, the UE may provide independently IDC issues for legacy purposes defined in Rel-16 from the IDC issues that may occur in case of multi-SIM. This can also avoid a possibility that legacy networks wrongly interpret a Rel-16 IDC report as one of the IDC cases defined in Rel-16.

| | |
|---|---|
| MUSIM-Assistance-r18 ::= | SEQUENCE { |
| affectedCarrierFreqListMUSIM-r18 | AffectedCarrierFreqList-r16 |

OPTIONAL,

| | |
|---|---|
| affectedCarrierFreqCombListMUSIM-r18 | AffectedCarrierFreqCombList-r16 |

OPTIONAL,
...
}

The advantage of the above approach is that the MUSIM assistance information is separated from the IDC assistance information and the IDC assistance information is not modified due to MUSIM.

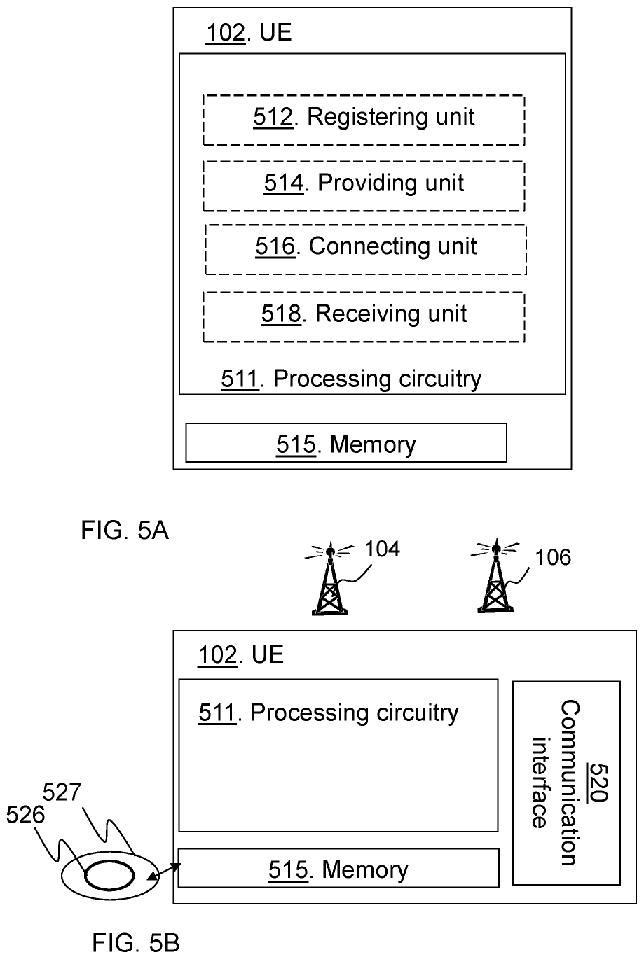

FIGS. 5A and 5B depict an example of a UE, such as the UE 102, in accordance with embodiments herein. The UE 102 may have at least a first SIM and a second SIM.

The UE 102 may comprise processing circuitry 511, e.g., one or more processors, configured to perform the methods herein.

The UE 102 may comprise a registering unit 512. The UE 102, the processing circuitry 511, and/or the registering unit 512 are configured to register with the first wireless communications network associated with the first SIM, by providing, to the first network node associated with the first wireless communications network, the first information comprising the one or more first capabilities of the UE 102. The UE 102, the processing circuitry 511, and/or the registering unit 512 are also configured to register, with the second wireless communications network associated with the second SIM, by providing, to the second network node 106 associated with the second wireless communications network, the second information on comprising the one or more second capabilities of the UE 102.

The one or more first capabilities of the UE 102 in the first information comprise UE capabilities relevant to the first wireless communications network. In some embodiments, the first information comprises information on full capabilities of the UE 102.

The UE 102, the processing circuitry 511, and/or the registering unit 512 may be configured to register with the first wireless communications network such that the UE 102, the processing circuitry 511, and/or the registering unit 512 are configured by the first network node based on the first information comprising one or more first capabilities of the UE 102. The first network node 104 may configure the UE 102 according to the first capabilities of the UE 102 provided to the first network node 104.

The UE 102, the processing circuitry 511, and/or the registering unit 512 are configured to register with the second network such that the UE 102, the processing circuitry 511, and/or the registering unit 512 are configured by the second network node 106 based on the second information comprising one or more second capabilities of the UE 102. The second network node 106 may configure the UE 102 according to the second capabilities of the UE 102 provided to the second network node 106.

The UE 102 may comprise a providing unit 514. The UE 102, the processing circuitry 511, and/or the providing unit 514 may be configured to, upon being connected to the first wireless communications network and using the one or more first capabilities from the first information for the service, trigger or provide the first request to the first network node to disable the set of capabilities from the one or more first capabilities in the first information provided to the first network node.

The UE 102, the processing circuitry 511, and/or the providing unit 514 may provide the first request that comprises the UE assistance information. The first request, which may comprise the UE assistance information, may be provided in response to occurrence of various events and in various circumstances which are discussed above in connection with FIG. 2 (act 206) and which are discussed elsewhere herein.

In some embodiments, the UE 102, the processing circuitry 511, and/or the providing unit 514 may provide the UE assistance to the first network node 104 before triggering the first request to the first network node 104. Thus, the UE assistance information, related to reduced capabilities of the UE 102 for MUSIM purposes, may be sent by the UE 102 to the first network node 104 in advance. In such embodiments, the UE assistance information may be stored in the first network node 104, and the UE assistance information may be activated using the trigger indication, such as, e.g., a lower-layer trigger indication, which the UE 102 may send to the first network node 104 when the UE 102 connects to another network node. Thus, in some embodiments, the UE assistance information related to the set of capabilities is stored in the first network node 104, and the UE 102, the processing circuitry 511, and/or the providing unit 514 may trigger the first request by sending a lower-layer trigger indication to the first network node 104 to activate the previously stored UE assistance information to disable the set of capabilities.

The UE 102, the processing circuitry 511, and/or the providing unit 514 may be configured to, when the UE 102 disconnects from the second network node 106 and continues to be connected to the first network node 104 using the reduced capabilities, trigger or provide the second request to the first network node 104 to reenable the set of capabilities for communication with the first network node 104.

The second request may comprise a UE assistance information. In some embodiments, the UE assistance information comprises one or more of: an indication in an IDC assistance information, an indication in the IDC assistance information in combination with a multiple SIM, MUSIM, indication, and MUSIM assistance information.

In some embodiments, the UE 102, the processing circuitry 511, and/or the providing unit 514 may be configured to provide the UE assistance information to the second network node 106 in advance, such that the UE assistance information may be stored in the second network node 106. The UE 102, the processing circuitry 511, and/or the providing unit 514 may be configured to then activate the UE assistance information, e.g., in response to a trigger indication. The second request may thus comprise the trigger indication, such as a lower-layer trigger indication.

In some embodiments, the UE 102, the processing circuitry 511, and/or the providing unit 514 may be configured to trigger adaptation or downgrading of ongoing services to a lower service quality when the first network node 104 accepts the first request and disables the set of capabilities.

In some embodiments, the UE 102, the processing circuitry 511, and/or the providing unit 514 may be configured to trigger adaptation or upgrading of ongoing services to a higher service quality when the first network node 104 accepts the second request.

The UE 102 may comprise a connecting unit 516, e.g., a transmitter or a transceiver. The UE 102, the processing circuitry 511, and/or the connecting unit 516 may be configured to connect and disconnect from a network node, such as the first network node 104, the second network node 106, and/or any other network node associated with a wireless communications network that is associated with a SIM in the UE 102.

In some embodiments, the UE 102, the processing circuitry 511, and/or the connecting unit 516 may be configured to connect to the first network node 104.

In some embodiments, the UE 102, the processing circuitry 511, and/or the connecting unit 516 may be configured to connect to the second network node 106 and use the set of capabilities for a service once the first network node 104 accepts the first request and disables the set of capabilities. Thus, the UE 102 becomes connected to the first network node 104 with reduced capabilities without the set of capabilities, and the UE 102 connects to the second network node 106 using reduced capabilities comprising the set of capabilities. Thus, at this point, the UE 102 is connected to both the first and second networks, such that the UE now is in RRC_CONNECTED mode in both first and second networks. The service(s) between the UE 102 and the first network node 104 continue with the reduced capabilities, and the UE 102 uses one or more services at the second network node 106.

In some embodiments, the UE 102, the processing circuitry 511, and/or the connecting unit 516 may be configured to revert to using at least a portion of the (reenabled, and previously disabled) set of capabilities of capabilities from the first information, to connect to the first network node 104 once the first network node 104 accepts the second request and reenables the at least a portion of the set of capabilities. Thus, the UE 102, the processing circuitry 511, and/or the connecting unit 516 may be configured to enable the UE 102 to connect to the first network node 104 using the set of capabilities, or a portion thereof, which were previously disabled to allow the UE 102 to connect to the second network node 106.

The UE 102, the processing circuitry 511, and/or the connecting unit 516 may be configured to receive a (re)configuration instruction from at least one of the first and second network nodes.

The UE 102 may comprise a receiving unit 518, e.g., a receiver or a transceiver. The UE 102, the processing circuitry 511, and/or the receiving unit 518 may be configured to receive one or more (re)configurations instruction from at least one of the first and second network nodes.

In some embodiments, the UE 102, the processing circuitry 511, and/or the receiving unit 518 may be configured to receive a reconfiguration message. In some embodiments, the UE 102, the processing circuitry 511, and/or the receiving unit 518 may be configured to receive an RRC reconfiguration message and/or a lower-layer indication from the first network node 104 when the first network node 104 accepts the first request and disables the set of capabilities.

In some embodiments, the UE 102, the processing circuitry 511, and/or the receiving unit 518 may be configured to receive an RRC reconfiguration message and/or a lower-layer indication from the first network node 104 when the first network node 104 accepts the second request and reenables the set of capabilities.

In some embodiments, the lower-layer indication comprises a MAC CE indication or a DCI/UCI indication.

In some embodiments, the UE 102, the processing circuitry 511, and/or the receiving unit 518 may be configured to receive the rate adaptation instruction. In some embodiments, the UE 102, the processing circuitry 511, and/or the receiving unit 518 may be configured to receive the rate adaptation instruction from the first network node 104 when the first network node 104 accepts the first request and disables the set of capabilities. In some embodiments, the rate adaptation instruction may comprise a recommendation for the UE to temporarily reduce a bitrate in one or both an uplink and downlink.

In some embodiments, the UE 102, the processing circuitry 511, and/or the receiving unit 518 may be configured to receive the second rate adaptation instruction. In some embodiments, the UE 102 receives the second rate adaptation instruction from the first network node 104 when the first network node 104 accepts the second request and reenables the set of capabilities. In some embodiments, the rate adaptation instruction comprises a recommendation for the UE to increase the bitrate in one or both an uplink and downlink.

The UE 102 further comprises a memory 515. The memory 515 comprises one or more units to be used to store data on, such as indications, contexts, measurements, thresholds, data related to nodes, and applications to perform the methods disclosed herein when being executed, and similar. Furthermore, the UE 102 may comprise a communication interface 520 such as comprising a transmitter, a receiver and/or a transceiver. In embodiments herein, the communication interface 520 may comprise dual Rx and Tx radios. In some embodiments, the communication interface 520 comprises more than two radios.

The methods according to the embodiments described herein for the UE 102 are respectively implemented using e.g., a computer program product 526 or a computer program, comprising instructions, i.e., software code portions, which, when executed on at least one processor, cause the at least one processor to carry out the actions described herein, as performed by the UE 102. The computer program product 526 may be stored on a computer-readable storage medium 527, e.g. a disc, a universal serial bus (USB) stick or similar. The computer-readable storage medium 527, having stored thereon the computer program product, may comprise the instructions which, when executed on at least one processor, cause the at least one processor to carry out the actions described herein, as performed by the UE 102. In some embodiments, the computer-readable storage medium may be a transitory or a non-transitory computer-readable storage medium. Thus, embodiments herein may disclose a UE for handling communication in a wireless communications network, wherein the UE comprises processing circuitry and a memory, the memory comprising instructions executable by the processing circuitry whereby the UE is operative to perform any of the methods herein.

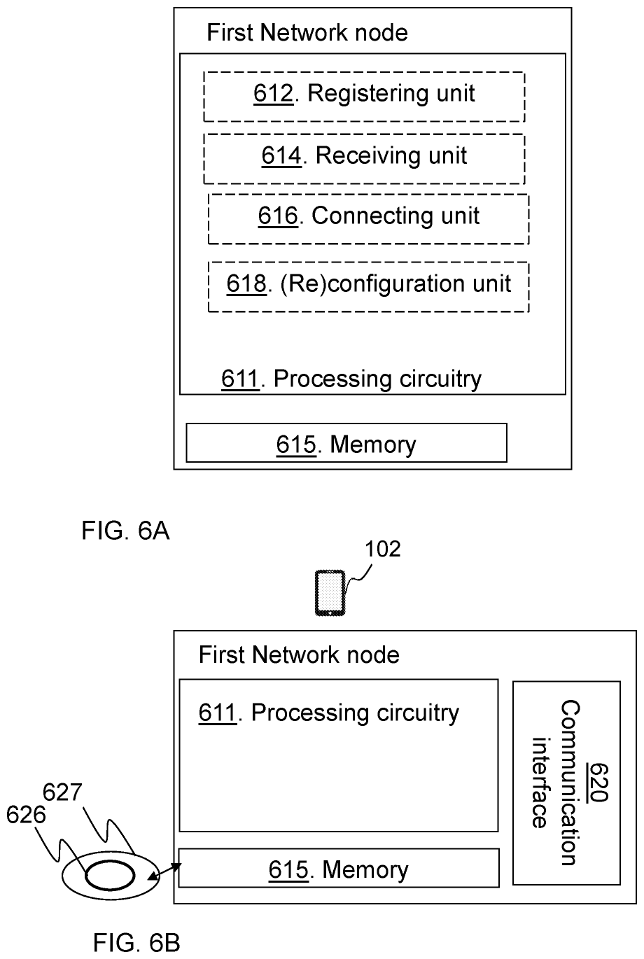

FIGS. 6A and 6B depict an example of a first network node, such as the first network 104 or the second network node 106, referred to as a network node, in accordance with embodiments herein. It should be appreciated that the first network node 104 and the second network node 106 (see FIG. 1A) may have the same or similar configurations, and are therefore not described separately herein. The first network node may be associated with a first wireless communication network, such as, e.g., the first wireless communication network 140 and the second wireless communication network 160, referred to herein as a wireless communication network. The first wireless communication network may be associated with one of SIMs of a UE, such that the UE 102. For example, the first wireless communication network may be associated with the first SIM, though it should be appreciated that SIMs are referred to herein as first and second for description purposes only.

The first network node may comprise processing circuitry 611, e.g. one or more processors, configured to perform the methods herein.

The first network node may comprise a registering unit 612. In some embodiments, the first network node, the processing circuitry 611, and/or the registering unit 612 are configured to obtain the registration from the UE 102 such that the UE 102 registers with or to the first wireless communication network. The first network node, the processing circuitry 611, and/or the registering unit 612 is configured to obtain the registration by receiving, from the UE 102, first information comprising the one or more first capabilities of the UE 102. The UE 102 is simultaneously registered with the first wireless communications network and at least one second wireless communications network associated with the second SIM. For example, the UE 102 may be simultaneously registered with the first and second wireless communication networks.

In some embodiments, the first network node, the processing circuitry 611, and/or the registering unit 612 may be configured to obtain the registration from the UE 102 by configuring the UE 102 based on the received first information on the one capabilities of the UE.

In some embodiments, the first network node, the processing circuitry 611, and/or the registering unit 612 may be configured to configure the UE 102 to provide UE assistance information to the network concerning reduced UE configuration for Multi-USIM purposes. The first network node can decide to configure the UE 102 to provide such information based on the awareness that the UE 102 is a Multi-USIM UE.

In some embodiments, depending on the UE assistance information provided by the UE 102, the first network node, the processing circuitry 611, and/or the registering unit 612 may be configured to reconfigure the UE by, e.g. activating or deactivating secondary cells (Scells).

The first network node may comprise a receiving unit 614, e.g. a receiver or a transceiver. The first network node, the processing circuitry 611, and/or the receiving unit 614 are configured to receive the first request from the UE 102 to disable the set of capabilities of the UE 102. The first network node, the processing circuitry 611, and/or the receiving unit 614 is configured to receive the first request to disable the set of capabilities from the one or more first capabilities in the first information comprising one or more capabilities of the UE 102, when the UE 102 is connected to the first wireless communications network and uses the one or more first capabilities from the first information for a service. The UE 102 may be disconnected from the second wireless communications network.

In some embodiments, the first network node, the processing circuitry 611, and/or the receiving unit 614 may be configured to receive the first request comprising the UE assistance information. In some embodiments, the first network node, the processing circuitry 611, and/or the receiving unit 614 may be configured to receive the first request comprising the trigger indication, such as a lower-layer trigger indication.

The UE assistance information may comprise one or more of: an indication in an IDC assistance information; an indication in the IDC assistance information in combination with a multiple SIM, MUSIM, indication; and a MUSIM assistance information. In some embodiments, the MUSIM assistance information is separated from the IDC assistance information and the IDC assistance information is not modified due to MUSIM.

In some embodiments, the first network node, the processing circuitry 611, and/or the receiving unit 614 are configured to receive, from the UE 102, the first request comprising a UE assistance information and/or a trigger indication that can activate the UE assistance information.

In some embodiments, the first network node, the processing circuitry 611, and/or the receiving unit 614 are configured to receive the first request, which may comprise the UE assistance information, in response to occurrence of various events and in various circumstances which are discussed above in connection with FIG. 2 (act 206) and elsewhere herein.

In some embodiments, the first network node, the processing circuitry 611, and/or the receiving unit 614 are configured to receive the UE assistance information before the first request is received by the first network node. In such embodiments, the UE assistance information may be received by the first network node in advance. In these embodiments, the first network node, e.g., a memory 615 of the first network node, may store the UE assistance information, and the stored UE assistance information may be activated at the first network node (so that the first network node (re)configures the UE 102 based on the UE assistance information) using the trigger indication, also referred to herein as an activation request. The trigger indication may be, e.g., a lower-layer trigger indication, which the first network node receives from the UE 102, e.g., as part of the first request. Thus, in some embodiments, the first network node, the processing circuitry 611, and/or the memory 615 may be configured to store the UE assistance information related to the set of capabilities, and the network node, the processing circuitry 611, and/or the receiving unit 614 may be configured to receive the first request comprises receiving a lower-layer trigger indication to the network node to activate the stored UE assistance information to disable the set of capabilities.

In some embodiments, the lower-layer trigger indication comprises a MAC CE trigger indication or an UCI trigger indication. In some embodiments, one or both the MAC CE trigger indication and an UCI trigger indication may be a single bit or a bitmap.

In some embodiments, the first network node, the processing circuitry 611, and/or the receiving unit 614 are configured to receive a second request to reenable the set of capabilities. In some embodiments, the first network node, the processing circuitry 611, and/or the receiving unit 614 may be configured to receive the second request to reenable the set of capabilities for communication with the wireless communications network when the UE 102 disconnects from the second wireless communications network and continues to be connected to the wireless communications network using the reduced capabilities.

In some embodiments, the first network node, the processing circuitry 611, and/or the receiving unit 614 are configured to receive the second request comprising a UE assistance information. In some embodiments, the first network node, the processing circuitry 611, and/or the receiving unit 614 are configured to receive the second request comprising a trigger indication, such as a lower-layer trigger indication. The UE assistance information may have been previously stored at the first network node, and it may be activated based on the trigger indication.

It should be appreciated that, in some embodiments, one or more operations performed by the registering unit 612 may additionally or alternatively be performed by the receiving unit 614.

The first network node may comprise a connecting unit 616. The first network node, the processing circuitry 611, and/or the connecting unit 616 may be configured to connect to the UE, such as the UE 102, or to any other UE. The first network node, the processing circuitry 611, and/or the connecting unit 616 may be configured to connect with more than one Ues which may register with the first network node and thus with the first wireless communications network with which the first network node is associated.

The first network node may comprise a (re)configuration unit 618. The first network node, the processing circuitry 611, and/or the (re)configuration unit 618 may be configured to provide, to the UE 102, a (re)configuration instruction, in response to received information on reduced capability of the UE 102. The (re)configuration unit 618 may also be referred to as a sending unit, since it is configured to send messages and/or instructions to the UE, such as the UE 102, for (re)configuration of the UE.

In some embodiments, the first network node, the processing circuitry 611, and/or the (re)configuration unit 618 may be configured to accept the first request. It should be appreciated that in some embodiments, additionally or alternatively, the first network node, the processing circuitry 611, and/or the connecting unit 616 may be configured to accept the first request.

In some embodiments, the first network node, the processing circuitry 611, and/or the (re)configuration unit 618 may be configured to accept the first request and disable the set of capabilities for communication with the UE 102, such that the UE 102 is connected to the wireless communications network with reduced capabilities without the set of capabilities, and the UE 102 is connected to the second wireless communications network with reduced capabilities comprising the set of capabilities.

In some embodiments, the first network node, the processing circuitry 611, and/or the (re)configuration unit 618 may be configured to send a reconfiguration message to the UE 102. The first network node, the processing circuitry 611, and/or the (re)configuration unit 618 may be configured to send an RRC reconfiguration message and/or a lower-layer indication when accepting the first request and disabling the set of capabilities for communication with the UE 102. In some embodiments, the lower-layer indication comprises a MAC CE indication or a DCI/UCI indication.

In some embodiments, the first network node, the processing circuitry 611, and/or the (re)configuration unit 618 may be configured to send the rate adaptation instruction to the UE 102. The first network node, the processing circuitry 611, and/or the (re)configuration unit 618 may be configured to send a rate adaptation instruction to the UE when accepting the first request and disabling the set of capabilities for communication with the UE 102.

In some embodiments, the sending the rate adaptation instruction to the UE comprises one or more out of:
providing a recommendation for the UE to temporarily reduce a bitrate in one or both an uplink and downlink;
triggering a renegotiation of an ongoing communication session with the UE; and
terminating at least one session with the UE.

In some embodiments, the first network node, the processing circuitry 611, and/or the (re)configuration unit 618 may be configured to accept the second request and reenable at least a portion of the set of capabilities for communication with the UE 102 to thereby allow the UE 102 to revert to using at least a portion of the set of capabilities from the information comprising one or more capabilities of the UE 102 to connect to the wireless communications network. Thus, the first network node, the processing circuitry 611, and/or the (re)configuration unit 618 may be configured to reenable at least a portion of the previously disabled capabilities from the set of capabilities.

In some embodiments, the first network node, the processing circuitry 611, and/or the (re)configuration unit 618 may be configured to send a reconfiguration message to the UE 102. In some embodiments, the first network node, the processing circuitry 611, and/or the (re)configuration unit 618 may be configured to send an RRC reconfiguration message and/or a lower-layer indication when accepting the second request and reenabling the set of capabilities for communication with the UE 102. In some embodiments, the lower-layer indication comprises a MAC CE indication or a DCI/UCI indication.

In some embodiments, the first network node, the processing circuitry 611, and/or the (re)configuration unit 618 may be configured to send the second rate adaptation instruction to the UE 102. The first network node, the processing circuitry 611, and/or the (re)configuration unit 618 may be configured to send the second rate adaptation instruction to the UE when accepting the second request and reenabling the set of capabilities for communication with the UE 102. In some embodiments, the second rate adaptation instruction comprises a recommendation for the UE to increase the bitrate in one or both the uplink and downlink.

In some embodiments, when the capabilities are restored for communications between the UE 102 and the first network node (e.g., for performance of a service), and if the bitrate has been previously reduced, which may be temporary, the first network node, the processing circuitry 611, and/or the (re)configuration unit 618 may send a new bitrate recommendation to allow applications/services to increase their bitrate again. In some embodiments, the first network node, the processing circuitry 611, and/or the (re)configuration unit 618 may trigger an upgrade of a service that has been previously renegotiated to a lower service quality. Thus, in some embodiments, the first network node, the processing circuitry 611, and/or the (re)configuration unit 618 may trigger an upgrade of a service that has been renegotiated to a lower service quality when accepting the second request and reenabling the set of capabilities for communication with the UE 102.

In some embodiments, the first network node, the processing circuitry 611, and/or the (re)configuration unit 618 may be configured to generate first network node's assistance information report to be sent to another node, and the first network node, the processing circuitry 611, and/or the (re)configuration unit 618 may be configured to send that assistance information to another network. In such embodiments, the assistance information may be generated based on the reception of the UE assistance information by the first network node, e.g. by the first network node, the processing circuitry 611, and/or the receiving unit 614. The first network node may send the assistance information generated by the first network node to another node, for example, for handover/Retrieve UE Context. In some embodiments, a source node/serving node may forward the received assistance information, and additionally include source node generated information that may be relevant for the target node.

As mentioned above and as shown in FIGS. 6A and 6B, the first network node comprises the memory 615. The memory 615 comprises one or more units to be used to store data on, such as indications, contexts, measurements, thresholds, data related to nodes, and applications to perform the methods disclosed herein when being executed, and similar. Furthermore, the first network node may comprise a communication interface 620 such as comprising a transmitter, a receiver and/or a transceiver.

The methods according to the embodiments described herein for the first network node are respectively implemented using e.g., a computer program product 626 or a computer program, comprising instructions, i.e., software code portions, which, when executed on at least one processor, cause the at least one processor to carry out the actions described herein, as performed by the first network node. The computer program product 626 may be stored on a computer-readable storage medium 627, e.g. a disc, a universal serial bus (USB) stick or similar. The computer-readable storage medium 627, having stored thereon the computer program product, may comprise the instructions which, when executed on at least one processor, cause the at least one processor to carry out the actions described herein, as performed by the first network node. In some embodiments, the computer-readable storage medium may be a transitory or a non-transitory computer-readable storage medium. Thus, embodiments herein may disclose a first network node for handling communication in a wireless communications network, wherein the first network node comprises processing circuitry and a memory, the memory comprising instructions executable by the processing circuitry whereby the first network node is operative to perform any of the methods herein.

In some embodiments, a more general term “network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments, the non-limiting term wireless device or user equipment (UE) is used and it refers to any type of wireless device communicating with a network node and/or with another wireless device in a cellular or mobile communication system. Examples of UE are IoT capable device, target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles, etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Embodiments herein relate to:

### Embodiment A1

A method performed by a user equipment, UE, (102) having at least two Subscriber Identity Modules, SIMs, for simultaneous communication with two or more networks, the method comprising:
registering with a first network associated with a first SIM, by providing, to a first network node associated with the first network, a first information comprising one or more capabilities of the UE (102);
registering with a second network associated with a second SIM, by providing, to a second network node (106) associated with the second network, a second information comprising one or more capabilities of the UE (102); and
upon being connected to the first network and using capabilities for a service in the first network, triggering a first request to the first network node to disable a set of capabilities from the capabilities.

### Embodiment A2

The method of embodiment A1, further comprising:
connecting to the second network node and using the set of capabilities for a service once the first network node accepts the first request and disables the set of capabilities, such that the UE (102) is connected to the first network node with reduced capabilities without the set of capabilities, and the UE (102) is connected to the second network node using reduced capabilities comprising the set of capabilities.

### Embodiment A3

The method of embodiment A2, further comprising:
when the UE (102) disconnects from the second network node and continues to be connected to the first network node using the reduced capabilities, triggering a second request to the first network node to reenable the set of capabilities for communication with the first network node; and
reverting to using at least a portion of the set of capabilities to connect to the first network node once the first network node accepts the second request and reenables the at least a portion of the set of capabilities.

In embodiments A1, the set of capabilities may be from the first information comprising one or more capabilities of the UE (102).

### Embodiment A4

The method of any of embodiments A1 to A3, wherein
registering with the first network comprises being configured by the first network node based on the first information comprising one or more capabilities of the UE; and/or
registering with the second network comprises being configured by the second network node based on the second information comprising one or more capabilities of the UE.

### Embodiment 1

A method performed by a user equipment, UE, (102) having at least two Subscriber Identity Modules, SIMs, for simultaneous communication with two or more networks, the method comprising:
registering with a first network associated with a first SIM, by providing, to a first network node associated with the first network, a first information comprising one or more capabilities of the UE (102);
registering with a second network associated with a second SIM, by providing, to a second network node associated with the second network, a second information comprising one or more capabilities of the UE (102); and
upon being connected to the first network and using the capabilities from the first information for a service, triggering a first request to the first network node to disable a set of capabilities from the capabilities in the first information provided to the first network node.

### Embodiment 2

The method of embodiment 1, further comprising:
connecting to the second network node and using the set of capabilities for a service once the first network node accepts the first request and disables the set of capabilities, such that the UE (102) is connected to the first network node with reduced capabilities without the set of capabilities, and the UE (102) is connected to the second network node using reduced capabilities comprising the set of capabilities.

### Embodiment 3

The method of embodiment 2, further comprising:
when the UE (102) disconnects from the second network node and continues to be connected to the first network node using the reduced capabilities, triggering a second request to the first network node to reenable the set of capabilities for communication with the first network node; and
reverting to using at least a portion of the set of capabilities from the first information to connect to the first network node once the first network node accepts the second request and reenables the at least a portion of the set of capabilities.

### Embodiment 4

The method of any of the embodiments 1 to 3, wherein
registering with the first network comprises being configured by the first network node based on the first information comprising one or more capabilities of the UE; and/or
registering with the second network comprises being configured by the second network node based on the second information comprising one or more capabilities of the UE.

### Embodiment 5

The method of any of the embodiments 1 to 4, wherein one or both the first request and the second request comprise a UE assistance information.

### Embodiment 6

The method of embodiment 5, wherein the UE assistance information comprises one or more of:
an indication in an In-Device-Coexistence (IDC) assistance information;
an indication in the IDC assistance information in combination with a multiple SIM, MUSIM, indication; and
a multiple SIM, MUSIM, assistance information.

### Embodiment 7

The method of embodiment 1, wherein a UE assistance information related to the set of capabilities is stored in the first network node, and wherein triggering the first request comprises sending a lower-layer trigger indication to the first network node to activate the UE assistance information to disable the set of capabilities.

### Embodiment 8

The method of embodiment 7, wherein the lower-layer trigger indication comprises a MAC CE trigger indication or an UCI trigger indication.

### Embodiment 9

The method of embodiment 7 or 8, comprising providing the UE assistance information to the first network node before triggering the first request to the first network node.

### Embodiment 10

The method of any of the embodiments 1 to 9, wherein
when the UE (102) is connected to the first network and disconnected from the second network, the UE (102) is in an RRC_CONNECTED mode in the first network and in an RRC_IDLE mode or an RRC_INACTIVE mode in the second network; and/or
when the UE (102) is connected to the first network and to the second network, the UE (102) is in an RRC_CONNECTED mode in the first and second networks.

### Embodiment 11

The method of embodiments 1 to 10, wherein the first information comprises one or more carrier frequencies, and wherein the set of capabilities from the capabilities in the first information comprises at least one carrier frequency from the one or more carrier frequencies.

### Embodiment 12

The method of embodiments 1 to 11, wherein the first request to the first network node is provided in response to:
a change in at least one condition of the UE (102) in at least one of the first and second networks, wherein the change in the at least one condition comprises a channel condition and/or a change of data demands.

### Embodiment 13

The method of embodiments 1 to 12, wherein the first request to the first network node is provided in response to: an expiration of a timer that determines when the UE can send requests to the first and/or second network nodes.

### Embodiment 14

The method of embodiments 1 to 13, wherein the first request to the first network node is provided in response to one or more out of:
availability of information to be sent in the first request that is different from information previously sent in a prior request to the first network node concerning a reduced set of capabilities;
an occurrence of an event;
an occurrence of network configured conditions;
a handover of the UE from a source cell to a target cell;
a reconfiguration procedure other than a handover;
a connection setup;
a re-establishment procedure;
a resume procedure; and
an indication that the UE is to be suspended.

### Embodiment 15

The method of embodiments 1 to 14, wherein the first request to the first network node is provided in response to: sending a UE assistance information message that no longer includes an indication of UE preference for a certain reduced UE configuration/capabilities for MUSIM purposes.

### Embodiment 16

The method of any of the embodiments 1 to 15, comprising receiving an RRC reconfiguration message and/or a lower-layer indication from the first network node when the first network node accepts the first request and disables the set of capabilities.

### Embodiment 17

The method of any of the embodiments 1 to 15, comprising receiving an RRC reconfiguration message and/or a lower-layer indication from the first network when the first network node accepts the second request and reenables the set of capabilities.

### Embodiment 18

The method of embodiment 16 or 17, wherein the lower-layer indication comprises a MAC CE indication or a DCI/UCI indication.

### Embodiment 19

The method of any of the embodiments 1 to 15, comprising receiving a rate adaptation instruction from the first network node when the first network node accepts the first request and disables the set of capabilities.

### Embodiment 20

The method of embodiment 19, wherein the rate adaptation instruction comprises a recommendation for the UE to temporarily reduce a bitrate in one or both an uplink and downlink.

### Embodiment 21

The method of embodiments 19 or 20, comprising triggering adaptation or downgrading of ongoing services to a lower service quality when the first network node accepts the first request and disables the set of capabilities.

### Embodiment 22

The method of embodiment 20 or 21, comprising receiving a second rate adaptation instruction from the first network node when the first network node accepts the second request and reenables the set of capabilities.

### Embodiment 23

The method of embodiment 22, wherein the second rate adaptation instruction comprising a recommendation for the UE to increase the bitrate in one or both the uplink and downlink.

### Embodiment 24

The method of any of the embodiments 29 to 23, comprising triggering adaptation or upgrading of ongoing services to a higher service quality when the first network node accepts the second request.

### Embodiment 25

The method of any of the embodiments 1 to 24, wherein the first network and the second network are different networks.

### Embodiment 26

The method of any of the embodiments 1 to 24, wherein the first network and the second network are the same network.

### Embodiment 27

The method of embodiment 25 or 26, wherein the first network is a first Public Land Mobile Network, PLMN, or a first non-public network (NPN), and wherein the second network is a second PLMN or a second NPN.

### Embodiment 28

The method of any of the embodiments 1 to 27, wherein
the first information comprising one or more capabilities of the UE comprises information on full capabilities of the UE relevant to the first network, and/or
the second information comprising one or more capabilities of the UE network comprises information on full capabilities of the UE relevant to the second network.

### Embodiment 29

A method performed by a network node associated with a wireless communications network, the method comprising:
obtaining a registration, with the wireless communications network associated with a first SIM, by receiving, from a user equipment, UE (102), information comprising one or more capabilities of the UE (102), wherein the UE (102) is simultaneously registered with the wireless communications network and at least one second wireless communications network associated with a second SIM; and
receiving a first request to disable a set of capabilities from the capabilities in the information comprising one or more capabilities of the UE (102), when the UE (102) is connected to the wireless communications network and uses the capabilities from the first information for a service, and the UE (102) is disconnected from the second wireless communications network.

### Embodiment 30

The method of embodiment 29, further comprising:
accepting the first request and disabling the set of capabilities for communication with the UE (102), such that the UE (102) is connected to the wireless communications network with reduced capabilities without the set of capabilities, and the UE (102) is connected to the second wireless communications network with reduced capabilities comprising the set of capabilities.

### Embodiment 31

The method of embodiment 30, further comprising:
when the UE (102) disconnects from the second wireless communications network and continues to be connected to the wireless communications network using the reduced capabilities, receiving a second request to reenable the set of capabilities for communication with the wireless communications network; and
accepting the second request and reenabling the set of capabilities for communication with the UE (102) to thereby allow the UE (102) to revert to using at least a portion of the reenabled set of capabilities from the information comprising one or more capabilities of the UE (102) to connect to the wireless communications network.

### Embodiment 32

The method of any of the embodiments 29 to 31, wherein
obtaining the registration from the UE (102) comprises configuring the UE (102) based on the received information comprising the capabilities of the UE (102).

### Embodiment 33

The method of any of the embodiments 29 to 32, comprising sending an RRC reconfiguration message and/or a lower-layer indication when accepting the first request and disabling the set of capabilities for communication with the UE (102).

### Embodiment 34

The method of any of embodiments 29 to 33, comprising sending an RRC reconfiguration message and/or a lower-layer indication when accepting the second request and reenabling the set of capabilities for communication with the UE (102).

### Embodiment 35

The method of embodiment 33 or 34, wherein the lower-layer indication comprises a MAC CE indication or a DCI/UCI indication.

### Embodiment 36

The method of any of embodiments 29 to 35, comprising sending a rate adaptation instruction to the UE when accepting the first request and disabling the set of capabilities for communication with the UE (102).

### Embodiment 37

The method of embodiment 36, wherein the sending the rate adaptation instruction to the UE comprises one or more out of:
providing a recommendation for the UE to temporarily reduce a bitrate in one or both an uplink and downlink;
triggering a renegotiation of an ongoing communication session with the UE;
terminating at least one session with the UE.

### Embodiment 38

The method of embodiment 36 or 37, comprising sending a second rate adaptation instruction to the UE when accepting the second request and reenabling the set of capabilities for communication with the UE (102), the second rate adaptation instruction comprising a recommendation for the UE to increase the bitrate in one or both the uplink and downlink.

### Embodiment 39

The method of any of embodiments 36 to 38, comprising triggering an upgrade of a service that has been renegotiated to a lower service quality when accepting the second request and reenabling the set of capabilities for communication with the UE (102).

### Embodiment 40

A user equipment, UE, (102) having multiple Subscriber Identity Modules, SIMs, for simultaneous communication with two or more networks, wherein the UE (102) is configured to:
register, with a first network associated with a first SIM, by providing, to a first network node associated with the first network, a first information comprising one or more capabilities of the UE (102);
register, with a second network associated with a second SIM, by providing, to a second network node associated with the second network, a second information comprising one or more capabilities of the UE (102); and
upon being connected to the first network and using the capabilities from the first information for a service, trigger a first request to the first network node to disable a set of capabilities from the capabilities in the first information provided to the first network node.

### Embodiment 41

The UE 102 of embodiment 40, wherein the UE (102) is further configured to:
connect to the second network node and use the set of capabilities for a service once the first network node accepts the first request and disables the set of capabilities, such that the UE (102) is connected to the first network node with reduced capabilities without the set of capabilities, and the UE (102) is connected to the second network node using reduced capabilities comprising the set of capabilities.

### Embodiment 42

The UE 102 of embodiment 41, wherein the UE (102) is further configured to:
when the UE (102) disconnects from the second network node and continues to be connected to the first network node using the reduced capabilities, trigger a second request to the first network node to reenable the set of capabilities for communication with the first network node; and
revert to using at least a portion of the set of capabilities from the first information to connect to the first network node once the first network node accepts the second request and reenables the at least a portion of the set of capabilities.

### Embodiment 43

The UE 102 of any of embodiments 40 to 43, wherein the UE (102) is configured to:
register with the first network by being configured by the first network node based on the first information comprising one or more capabilities of the UE; and/or
register with the second network by being configured by the second network node based on the second information comprising one or more capabilities of the UE.

### Embodiment 44

A network node (104, 106) associated with a wireless communications network, the network node being configured to:
obtain a registration with the wireless communications network associated with a first SIM, by receiving, from a user equipment, UE (102), information comprising one or more capabilities of the UE (102), wherein the UE (102) is simultaneously registered with the wireless communications network and at least one second wireless communications network associated with a second SIM; and
receive a first request to disable a set of capabilities from the capabilities in the information comprising one or more capabilities of the UE (102), when the UE (102) is connected to the wireless communications network and uses the capabilities from the first information for a service, and the UE (102) is disconnected from the second wireless communications network.

### Embodiment 45

The network node (104, 106) of embodiment 44, the network node further being configured to:
accept the first request and disable the set of capabilities for communication with the UE (102), such that the UE (102) is connected to the wireless communications network with reduced capabilities without the set of capabilities, and the UE (102) is connected to the second wireless communications network with reduced capabilities comprising the set of capabilities.

### Embodiment 46

The network node (104, 106) of embodiment 45, the network node further being configured to:
when the UE (102) disconnects from the second wireless communications network and continues to be connected to the wireless communications network using the reduced capabilities, receive a second request to reenable the set of capabilities for communication with the wireless communications network; and
accept the second request and reenabling the set of capabilities for communication with the UE (102) to thereby allow the UE (102) to revert to using at least a portion of the reenabled set of capabilities from the information comprising one or more capabilities of the UE (102) to connect to the wireless communications network.

### Embodiment 47

The network node (104, 106) of any of the embodiments 44 to 46, the network node further being configured to:
obtain the registration from the UE (102) by configuring the UE (102) based on the received information comprising the capabilities of the UE (102).

### Embodiment 48

The network node (104, 106) of any of the embodiments 44 to 47, the network node further being configured to:
send an RRC reconfiguration message and/or a lower-layer indication when accepting the first request and disabling the set of capabilities for communication with the UE (102).

### Embodiment 49

The network node (104, 106) of any of the embodiments 44 to 48, the network node further being configured to:
send an RRC reconfiguration message and/or a lower-layer indication when accepting the second request and reenabling the set of capabilities for communication with the UE (102).

### Embodiment 50

The network node (104, 106) of embodiment 48 or 49, wherein the lower-layer indication comprises a MAC CE indication or a DCI/UCI indication.

### Embodiment 51

The network node (104, 106) of any of embodiments 44 to 50, the network node further being configured to:
send a rate adaptation instruction to the UE when accepting the first request and disabling the set of capabilities for communication with the UE (102).

### Embodiment 52

The network node (104, 106) of embodiment 51, wherein the network node is configured to send the rate adaptation instruction to the UE by one or more out of:
providing a recommendation for the UE to temporarily reduce a bitrate in one or both an uplink and downlink;
triggering a renegotiation of an ongoing communication session with the UE; and
terminating at least one session with the UE.

### Embodiment 53

The network node (104, 106) of embodiment 51 or 52, the network node further being configured to:
send a second rate adaptation instruction to the UE when accepting the second request and reenabling the set of capabilities for communication with the UE (102), the second rate adaptation instruction comprising a recommendation for the UE to increase the bitrate in one or both the uplink and downlink.

### Embodiment 54

The network node (104, 106) of any of embodiments 50 to 53, the network node further being configured to:
trigger an upgrade of a service that has been renegotiated to a lower service quality when accepting the second request and reenabling the set of capabilities for communication with the UE (102).

### Embodiment 55

A computer program (526) comprising instructions, which, when executed by at least one processor (511), cause the at least one processor (511) to perform any of the embodiments herein as performed by the UE (102).

### Embodiment 56

A carrier (527) comprising the computer program (526) of embodiment 55, wherein the carrier (527) is one of an electronic signal, an optical signal, an electromagnetic signal, a magnetic signal, an electric signal, a radio signal, a microwave signal, or a computer-readable storage medium.

### Embodiment 57

A computer program (626) comprising instructions, which, when executed by at least one processor (611), cause the at least one processor (611) to perform any of the embodiments herein as performed by the network node (104, 106).

### Embodiment 58

A carrier (627) comprising the computer program (626) of embodiment 57, wherein the carrier (627) is one of an electronic signal, an optical signal, an electromagnetic signal, a magnetic signal, an electric signal, a radio signal, a microwave signal, or a computer-readable storage medium.

The present disclosure further comprises embodiments, and any combination of the embodiments, according to any one or more of FIGS. 1, 2, 3, 4, 5A, 5B, 6A, and 6B.

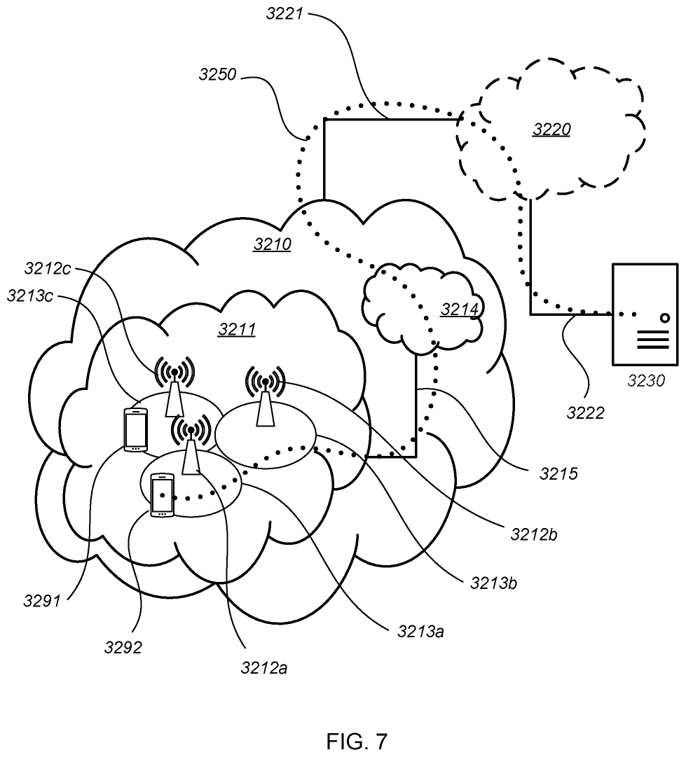

FIG. 7 shows a telecommunication network connected via an intermediate network to a host computer in accordance with some embodiments. With reference to FIG. 7, in accordance with an embodiment, a communication system includes a telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the network nodes above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of Ues 3291, 3292 are illustrated in this example being examples of the UE 102 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 7 as a whole enables connectivity between the connected Ues 3291, 3292 and host computer 3230. The connectivity may be described as an over-the-top (OTT) connection 3250. Host computer 3230 and the connected Ues 3291, 3292 are configured to communicate data and/or signalling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

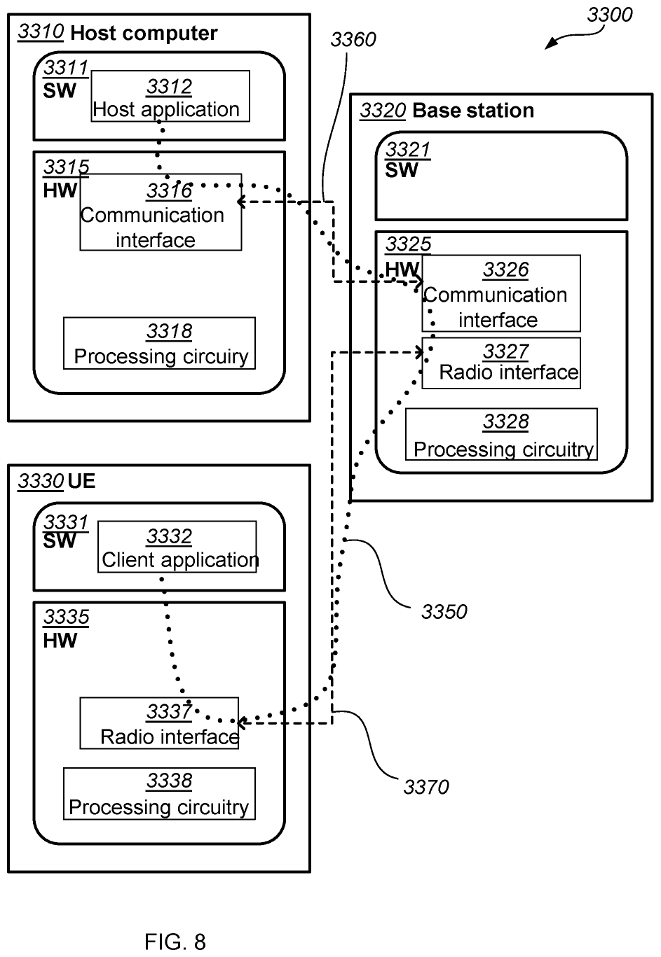

FIG. 8 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 8. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 8) served by base station 3320. Communication interface 3326 may be configured to facilitate connection 3360 to host computer 3310. Connection 3360 may be direct or it may pass through a core network (not shown in FIG. 8) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 8 may be similar or identical to host computer 3230, one of base stations 3212a, 3212b, 3212c and one of Ues 3291, 3292 of FIG. 7, respectively. This is to say, the inner workings of these entities may be as shown in FIG. 8 and independently, the surrounding network topology may be that of FIG. 7.

In FIG. 8, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments make it possible communicate using a UE with multiple SIMs in an efficient manner. Thereby the communication may be performed in an efficient manner resulting in better responsiveness.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signalling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors, etc.

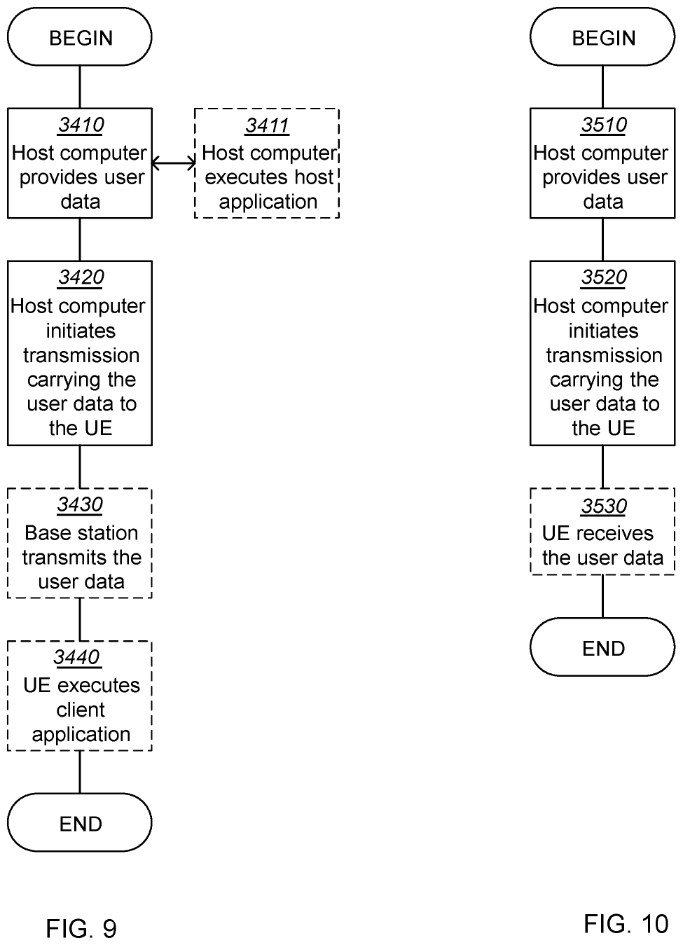

FIG. 9 shows methods implemented in a communication system including a host computer, a base station and a user equipment in accordance with some embodiments.

FIG. 9 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 9 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 10 shows methods implemented in a communication system including a host computer, a base station and a user equipment in accordance with some embodiments.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

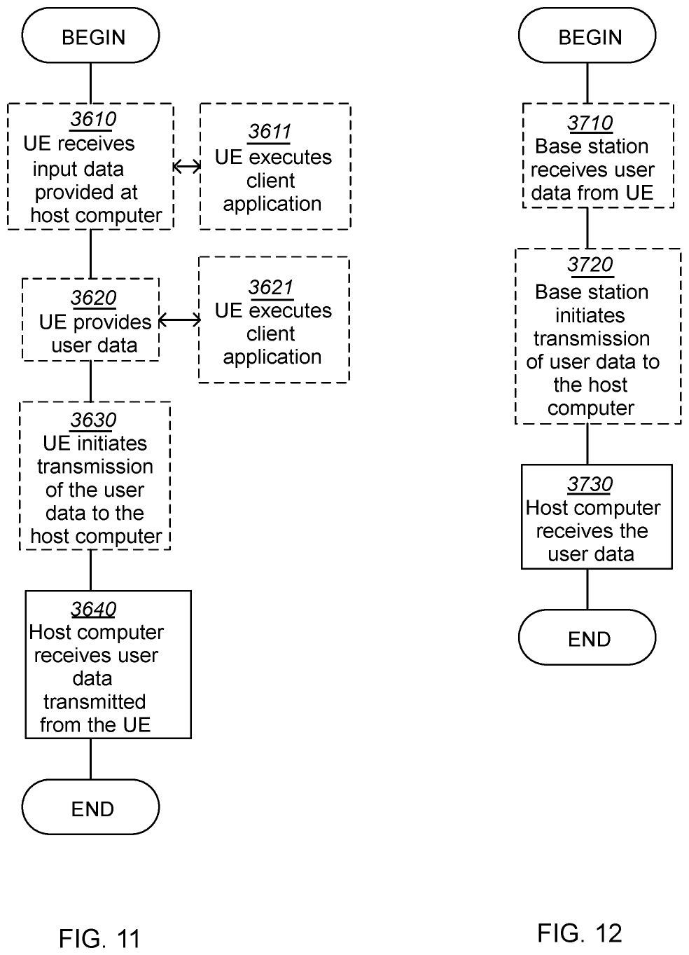

FIG. 11 shows methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 12 shows methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 12 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### REFERENCES

1. RP-202895, “Support for Multi-SIM devices for LTE/NR,” 3GPP TSG RAN Meeting #90e. Electronic Meeting, Dec. 7-11, 2020. China Telecom, China Unicom.
2. RP-212015, “Enhanced support for multi-SIM devices in Rel-18,” 3GPP TSG RAN 93e. Electronic Meeting, Sep. 13-17, 2021; source: vivo.

1. A method performed by a user equipment, UE, having at least two Subscriber Identity Modules, SIM, for handling communication with two or more networks, the method comprising:
registering with a first wireless communications network associated with a first SIM, by providing, to a first network node associated with the first wireless communications network, a first information comprising one or more first capabilities of the UE;
registering with a second wireless communications network associated with a second SIM, by providing, to a second network node associated with the second wireless communications network, a second information comprising one or more second capabilities of the UE; and
upon being connected to the first wireless communications network and using the one or more first capabilities from the first information for a service, triggering a first request to the first network node to disable a set of capabilities from the one or more first capabilities in the first information provided to the first network node.

2. The method of claim 1, further comprising:
connecting to the second network node and using the set of capabilities for a service once the first network node accepts the first request and disables the set of capabilities, such that the UE is connected to the first network node with reduced capabilities without the set of capabilities, and the UE is connected to the second network node using the set of capabilities.

3. The method of claim 2, further comprising:
when the UE disconnects from the second network node and continues to be connected to the first network node using the reduced capabilities, triggering a second request to the first network node to reenable the set of capabilities for communication with the first network node; and
reverting to using at least a portion of the set of capabilities from the first information to connect to the first network node once the first network node accepts the second request and reenables the at least a portion of the set of capabilities.

4. The method of claim 3, further comprising receiving a second rate adaptation instruction from the first network node when the first network node accepts the second request and reenables the set of capabilities.

5. The method of claim 4, wherein the second rate adaptation instruction comprises a recommendation for the UE to increase the bitrate in one or both the uplink and downlink.

6. The method of claim 3, further comprising triggering adaptation or upgrading of ongoing services to a higher service quality when the first network node accepts the second request.

7. (canceled)

8. The method of claim 1, wherein
one or both the first request and the second request comprise a UE assistance information comprising one or more of:
an indication in an In-Device-Coexistence, IDC, assistance information;
an indication in the IDC assistance information in combination with a multiple SIM, MUSIM, indication; and
a MUSIM assistance information.

9.-14. (canceled)

15. The method of claim 1, wherein the first request to the first network node is provided in response to an expiration of a timer that determines when the UE can send requests to one or both of the first and the second network nodes.

16. (canceled)

17. (canceled)

18. The method of claim 1, further comprising receiving a radio resource control, RRC, reconfiguration message from the first network node when the first network node accepts the first request and disables the set of capabilities and accepts the second request and reenables the set of capabilities.

19.-24. (canceled)

25. A method performed by a first network node associated with a first wireless communications network, the method comprising:
obtaining a registration, with the first wireless communications network associated with a first Subscriber Identity Module, SIM, by receiving, from a user equipment, UE, first information comprising one or more first capabilities of the UE, the UE being simultaneously registered with the first wireless communications network and at least one second wireless communications network associated with a second SIM; and
receiving a first request to disable a set of capabilities from the one or more first capabilities in the first information, when the UE is connected to the first wireless communications network and uses the one or more first capabilities from the first information for a service.

26. The method of claim 25, further comprising:
accepting the first request and disabling the set of capabilities for communication with the UE, such that the UE is connected to the first wireless communications network with reduced capabilities without the set of capabilities.

27. The method of claim 26, further comprising:
when the UE disconnects from the second wireless communications network and continues to be connected to the first wireless communications network using the reduced capabilities, receiving a second request, from the UE, to reenable the set of capabilities for communication with the first wireless communications network; and
accepting the second request and reenabling the set of capabilities for communication with the UE to thereby allow the UE to revert to using at least a portion of the reenabled set of capabilities from the first information comprising the one or more first capabilities of the UE to connect to the first wireless communications network.

28. The method of claim 27, further comprising sending a radio resource control, RRC, reconfiguration message when accepting the second request and reenabling the set of capabilities for communication with the UE.

29. The method of claim 27, further comprising sending a second rate adaptation instruction to the UE when accepting the second request and reenabling the set of capabilities for communication with the UE, the second rate adaptation instruction comprising a recommendation for the UE to increase the bitrate in one or both the uplink and downlink.

30. The method of claim 27, further comprising triggering an upgrade of a service that has been renegotiated to a lower service quality when accepting the second request and reenabling the set of capabilities for communication with the UE.

31. The method of claim 25, further comprising sending a radio resource control, RRC, reconfiguration message when accepting the first request and disabling the set of capabilities for communication with the UE.

32. The method of claim 25, further comprising sending a rate adaptation instruction to the UE when accepting the first request and disabling the set of capabilities for communication with the UE.

33. (canceled)

34. A user equipment, UE, having at least two Subscriber Identity Modules, SIM, for communication with two or more networks, the UE being configured to:
register with a first wireless communications network associated with a first SIM, by providing, to a first network node associated with the first wireless communications network, a first information comprising one or more first capabilities of the UE;
register with a second wireless communications network associated with a second SIM, by providing, to a second network node associated with the second wireless communications network, a second information comprising one or more second capabilities of the UE; and
upon being connected to the first wireless communications network and using the one or more first capabilities from the first information for a service, trigger a first request to the first network node to disable a set of capabilities from the one or more first capabilities in the first information provided to the first network node.

35. The UE according to claim 34, wherein the UE is further configured to connect to the second network node and using the set of capabilities for a service once the first network node accepts the first request and disables the set of capabilities, such that the UE is connected to the first network node with reduced capabilities without the set of capabilities, and the UE is connected to the second network node using the set of capabilities.

36. A first network node associated with a first wireless communications network, the network node being configured to:
obtain a registration, with the first wireless communications network associated with a first Subscriber Identity Module, SIM, by receiving, from a user equipment, UE, first information comprising one or more first capabilities of the UE, the UE is being simultaneously registered with the first wireless communications network and at least one second wireless communications network associated with a second SIM; and
receive a first request to disable a set of capabilities from the one or more first capabilities in the information, when the UE is connected to the first wireless communications network and uses the one or more first capabilities from the first information for a service.

37. The first network node according to claim 36, wherein the first network node is further configured to communicate with the UE, such that the UE is connected to the first wireless communications network with reduced capabilities without the set of capabilities.

38.-39. (canceled)
